(19) United States
(12) Patent Application Publication
(10) Pub. No.: US 2006/0190221 A1
(43) Pub. Date: Aug. 24, 2006

(54) System and method for design of a fluid delivery system

(76) Inventor: Kevin S. Bennett, San Jose, CA (US)

Correspondence Address: SPRINKLE IP LAW GROUP, 1301 W. 25TH STREET, SUITE 408, AUSTIN, TX, 78705, US

(21) Appl. No.: 11/331,284

(22) Filed: Jan. 12, 2006

Related U.S. Application Data
(60) Provisional application No. 60/644,093, filed on Jan. 14, 2005.
(60) Provisional application No. 60/653,772, filed on Feb. 17, 2005.

(51) Int. Cl. G06F 17/50

(52) U.S. Cl. 703/1

(57) ABSTRACT

Embodiments of the present invention provide system and methods for design of the fluid delivery systems. One embodiment of the present invention includes a design program that is executable to provide a graphical user interface that allows a user to specify architecture independent flow functionalities for locations in a schematic of a fluid delivery system and specify an architecture independent component type corresponding to a flow functionality for at least one location for which the user specified a flow functionality. The design program can then determine architecture dependent flow routing parts for the schematic locations for which the user specified flow functionalities for one or more architectures.

### RELATED APPLICATIONS

The present application, under 35 U.S.C. §119(e), claims priority to and benefit of U.S. Provisional Patent Application No. 60/644,093 entitled “System and Method of Design of a Fluid Delivery System”, by Bennett, filed Jan. 14, 2005 and U.S. Provisional Patent Application No. 60/653,772 entitled “System and Method of Design of a Fluid Delivery System”, by Bennett, filed Feb. 17, 2005, both of which are hereby fully incorporated by reference.

### TECHNICAL FIELD OF THE INVENTION

Embodiments of the invention relate generally to the design of fluid delivery systems and more particularly to systems and methods for configuring gas panels.

### BACKGROUND

Fluid delivery systems in the semiconductor industry are a large component of wafer fabrication tools. They are used to provide fluids or a mixture of fluids to the wafer chamber at specific flow rates and pressures using a set of components (such as valves, regulators, MFC's, etc) connected to each other in a wide variety of flow schematics.

A typical fluid delivery system uses tubing and seals to connect fluid delivery components together to achieve a certain schematic. Other systems, referred to as modular fluid delivery systems, utilize a number of blocks containing flow paths that can be assembled to match a schematic. There are several architectures available for fluid delivery systems and, typically, components suitable for one architecture are not suitable for another architecture.

Designing a fluid delivery system is a time consuming task. To alleviate the burdens of design, several software programs have been developed. These software programs, however, are not robust as they tend to focus only one aspect of fluid delivery system design and are limited to a single architecture.

A software program known as Gasware was developed and used by Celerity Corporation. Gasware was a specific design tool written for one specific modular architecture. The software was designed and utilized as an engineering tool, as a level of knowledge typically only possessed by engineers was needed to use the software and properly design a system. The software did not automatically configure any new “parts” or “manifolds”, did not configure heater solutions, and its level of automation was confined to quotations and CAD output. Gasware was able to output to ProEngineer CAD software only.

Another program was developed by Swagelok. This program provided a free-form drawing tool to construct a gas schematic. In defining the schematic the user would be forced, at that time, to specify which specific parts (i.e., manufacturer and part number) would be used and where. With this input, the software would in turn output a Bill of Materials for Swagelok's IGC2 modular architecture and a top level view of the panel without components. There was no output to a CAD system.

Yet another program, Design Pro, is designed to provide a listing of parts for a gas panel design. Design Pro only works for the Parker IntraFlow architecture and does not integrate with CAD programs and does not provide cost estimates.

Companies that perform the assembly of fluid delivery systems, known as “integrators”, typically design and build with several different architectures. However, the prior software programs are specifically designed for one modular fluid delivery architecture. Their purpose has been to promote the architecture they were designed for, and no others. This severely limits the benefits of using such software.

In addition, prior art software programs do not possess the coded intellect of automatically deciding which parts to use and where to use the m based on only a schematic input. This requires their user to be an experienced engineer that has a complete level of understanding for the architecture being designed with.

Another limitation of prior art software is the limitation of designing parts on the fly. A good example of this is manifolds. The prior art software will only allow the user to design with manifold structures that have manually been configured in the CAD software. This adds up to much lost engineering time spent making assemblies, modeling parts, and configuring fully dimensioned machine and weld drawings.

Yet another limitation of prior art software is the inability to configure fully automatic heater solutions for fluid delivery systems with automatic part creation and CAD output.

### SUMMARY OF THE INVENTION

Embodiments of the present invention provide systems and methods of designing fluid delivery systems that eliminate, or at least substantially reduce, the shortcomings of prior art systems and methods for designing fluid delivery systems. One embodiment of the present invention includes a design program that is executable to provide a graphical user interface that allows a user to specify architecture independent flow functionalities for locations in a schematic of a fluid delivery system and specify an architecture independent component type corresponding to a flow functionality for at least one location for which the user specified a flow functionality. The design program can then determine architecture dependent flow routing parts for the schematic locations for which the user specified flow functionalities for one or more architectures.

Another embodiment of the present invention includes a method for designing fluid delivery systems that comprises receiving architecture independent flow functionalities for locations in a schematic of a fluid delivery system, for at least a first location for which the user specifies a flow functionality, receiving an architecture independent component type corresponding to the flow functionality for that location and determining architecture dependent flow routing parts of the schematic locations for which the user specified flow functionalities for one or more architectures.

Yet another embodiment of the present invention comprises a system for designing a fluid flow panel that includes a set of computer instructions stored on a computer readable medium. The set of computer instructions include instructions executable to provide a graphical user interface to a user that allows the user to specify architecture impendent specifications for a flow routing layer and component layer for various locations in a schematic of a fluid delivery system and determine at least one architecture dependent set of parts for a gas panel based on the architecture independent specifications for the flow routing layer and component layer, wherein the set of parts includes a set of flow routing parts and a set of components.

Yet another embodiment of the present invention includes a design program that maintains an n-dimensional array representing criteria for selecting substrate blocks for each of a plurality of architectures, provides a graphical user interface to a user that comprises a schematic grid, for locations in the schematic grid, allows a user to specify architecture independent flow functionalities, for at least one location in the schematic grid, allows the user to specify a component type corresponding to the flow functionality specified for that location, and populates the schematic grid with schematic symbols corresponding to the flow functionalities and component types specified for the locations in the schematic grid. Additionally, for each of the plurality of architectures, the design program determines a set of substrate blocks for that architecture using the n-dimensional array for that architecture and the specified architecture independent flow functionalities and determines a set of architecture dependent components. The design program generates a virtual gas panel design for at least one architecture based on the determined substrate blocks for that architecture and architecture dependent components for that architecture. The design program can output the gas panel design as quote, bill of materials or CAD drawings.

A large improvement over the prior art is the ability of embodiments of the present invention to design with any modular fluid delivery architecture, including older VCR style designs. The program can be in a design generic fashion, such that modules of this code can be used and reused independent of what architecture the user wishes to design with. In addition, according to one embodiment, code arrays are configured into two dimensional visual grids wherein configuration intellect logic is contained. These grids are utilized by the software to decide which parts are used and where they are used to accomplish the flow schematic provided by the user. The utilization of the arrays in this fashion allows someone to develop a new design logic or architecture into the software without having to change any hard code.

Note that the schematic input of the user is architecture independent. The user has the ability to design the schematic, and then select which architecture to design it in. This is of great benefit to users. Not only does this provide an engineering tool for all of the architectures utilized by the user, but also provides, for instance, one single input that can be used to compare CAD and quotation outputs of several designs, such that the most inexpensive and efficient design can be chosen.

Another major improvement over the prior art is the configuration intellect of the software. The user of the software need not have any knowledge of the architecture to design a full quotation and CAD drawing package. The user must simply define the flow schematic, and the software will complete all engineering required. The software will automatically decide which parts to use, where to use them, what angle to install them at, what seals are needed, what fasteners, etc. This opens up a whole new use for an engineering efficiency tool in that one need not be an engineer to properly use it. This could provide great cost savings for companies when, for example, salesmen or technicians could be generating quotations without ever interfacing with engineering.

Another improvement over the prior art is the automatic CAD creation, assembly, and inventory creation of custom parts such as weldments manifold connections, heaters, and mounting plates. These parts are custom in that they are not used over and over again, and the program will automatically create them on the fly. It can calculate the necessary dimensions of such parts, model them in the selected CAD system, create fully dimensioned machine/weld drawings, as well as create them in the inventory control system.

Another improvement over the prior art is the ability to integrate with several different CAD programs. Embodiments of the present invention provide the ability to design any modular architecture with several CAD systems. Different companies will use different architectures, and will use different CAD systems. This flexibility leads to a much larger market for the present invention and its applications.

Embodiments of the present invention have, in tests, yielded a minimum of 10× reduction in engineering time as compared to manual CAD and quotation configuration for various panel designs. This provides an order of magnitude increase in efficiency and cost savings. Not only will users using embodiments of the present invention be saving money on non-recurring engineering overhead, they will also be able to provide quotations within hours as opposed to weeks. The integration with the inventory system will streamline the entire manufacturing procedure for fluid delivery systems and lead to even more savings and level of efficiency.

### BRIEF DESCRIPTION OF THE FIGURES

A more complete understanding of the present invention and the advantages thereof may be acquired by referring to the following description, taken in conjunction with the accompanying drawings in which like reference numbers indicate like features and wherein:

FIG. 1 is a diagrammatic representation of a system of designing fluid delivery systems;

FIG. 2 is a diagrammatic representation of a method for designing fluid delivery systems;

FIGS. 3A and 3B are diagrammatic representations of a screen shot for a graphical user interface (“GUI”) that allows a user to specify architecture independent flow functionalities and component types for a schematic;

FIGS. 4A and 4B are diagrammatic representations of a screen shot for a GUI that allows a user to specify sandwich components for a schematic;

FIGS. 5A and 5B are diagrammatic representations of tables in an n-dimensional array for selecting flow routing parts;

FIGS. 6A, 6B and 6C provide diagrammatic representations of a screen shot for a GUI that allows a user to provide a manifold specification;

FIGS. 7A, 7B and 7C provide diagrammatic representations of a screen shot for a GUI that allows a user to provide a heater specification;

FIGS. 8A, 8B and 8C provide diagrammatic representations of quotes for a panel design;

FIG. 8D illustrates a summary screen for the quote of FIGS. 8A and 8C;

FIG. 9A is a diagrammatic representation of a completed schematic;

FIGS. 9B and 9C are diagrammatic representations of a grid for storing information corresponding to the schematic of FIG. 9A;

FIG. 10 is a diagrammatic representation of a transform matrix for a CAD program;

FIGS. 11A-11H are example CAD outputs for a gas panel design; and

FIG. 12 is a flow chart of a method for designing a gas panel according to one embodiment of the present invention.

### DETAILED DESCRIPTION

Preferred embodiments of the present invention are illustrated in the FIGUREs, like numerals being used to refer to like and corresponding parts of the various drawings.

Many fluid delivery system designs or architectures utilize a modular design logic; they use a set number of parts to configure an infinite number of schematic layouts. The present invention provides a design generic system and method, such that the present invention can be utilized with any modular or other type architecture, not limited to particular fluid delivery systems.

Embodiments of the present invention streamline the engineering that is required to design a fluid delivery panel. According to one embodiment, the user simply provides a schematic input and from there various gas panel designs can be determined. The user can output quotes, bills of materials (“BOM”) and full CAD assembly and drawing packages.

According to one embodiment, a design program can abstract gas panel design into three layers: the component layer, the flow routing layer and the manifold layer. The component layer corresponds to the parts that are used to act on or control the gas (e.g., filters, mass flow controllers (“MFC”), valves or other components). The flow routing layer corresponds to the parts (e.g., substrate blocks, tubing, etc.) that route gas between components in a gas stick. The manifold layer corresponds to the parts that route fluid between gas sticks that are not otherwise accounted for in the flow routing layer.

The design program can allow the user to specify qualities for various locations in a schematic for each layer. From the information provided by the user, the design program can apply configuration logic to a set of design data (e.g., arranged in a database, as a set of arrays or according to other data storage schemes) to select the appropriate parts for the flow routing layer and the component layer. Additionally, the design program can determine various features of the manifold layer, such as the number of weldments required, labor required to build the manifold, parts required for the manifold and other features of the manifold layer. In addition, the design program can allow a user to provide heater specifications. From the heater specifications, the design program can determine various properties of a heater.

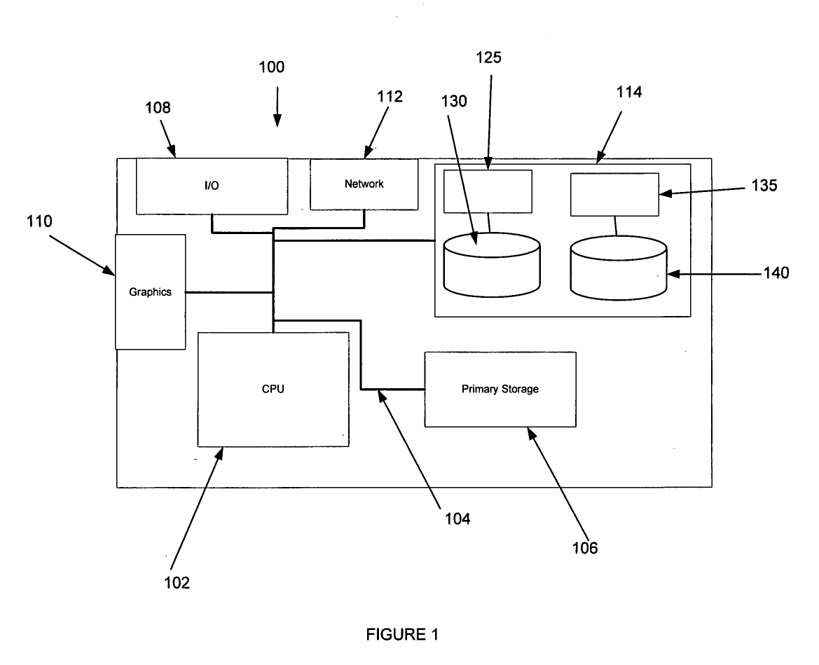

According to one embodiment, the design system can be implemented as a set of software instructions stored on a computer readable medium that are executable by a processor. FIG. 1 provides a diagrammatic representation of one system 100 for designing a fluid delivery system. For the purposes of example, system 100 can comprise a main processor 102, a bus 104, a primary storage medium 106, an I/O interface 108, a graphics interface 110, a network interface 112 and a secondary storage medium 114. Other devices may be connected to or be part of system 100 including, by way of example, but not limitation, controllers, a display, a mouse, a keyboard, and so forth. Additionally, system 100 can include additional interfaces to communicate to additional networks using various protocols and can include interfaces for administrative functions.

The main processor 102 communicates with the other components by way of the bus 104. This main processor 102 can be a general purpose processor, a limited processor such as an ASIC or microcontroller, or any other instruction execution machine. The primary storage 106 (e.g., RAM, ROM, magnetic storage or other storage medium known in the art) can provide transient memory or storage space for use by programs executing on the main processor 102. The main processor 102 communicates with the primary storage in any manner known in the art. Secondary storage medium 114 can also include any computer readable storage medium, such as a hard drive, CD-ROM, floppy, tape drive, optical storage medium, memory or other storage medium known in the art. The main processor 102 can communicate with the secondary storage to read and/or write the storage medium 114.

System 100 may communicate with other computing devices (e.g., user devices, network servers, etc.) by way of networks using network interfaces (e.g., network interface 112). Computer instructions running on the main processor may then access other computers across the network in any of the conventional ways (e.g., by executing “protocols” which affect the transmission and reception of protocol data units, packages, etc. over the data transmission network).

In one embodiment of the present invention, storage medium 114 can store a set of computer instructions 125 (“design program 125”) that is executable by processor 102. During execution, portions of design program 125 and data can be stored in primary storage 106, as would be understood by those of ordinary skill in the art. Processor 102 can execute design program 125 to display content to a user through a graphical user interface (“GUI”) to allow a user to define a gas delivery system.

Design program 125 can include design data 130 defining various parts, selection criteria and other data for fluid delivery systems of multiple architectures. Design data 130 can include searchable arrays, a database of components and other data structures. Based on the user inputs, design program 125 can search the arrays to determine various components (e.g., flow components, substrate blocks and other parts) for a fluid delivery system. Design data is shown on a single storage medium for the sake of convenience. According to other embodiments design data 130 can be distributed across data storage media and stored according to a variety of data storage formats.

According to one embodiment, design program 125 is implemented in Microsoft Excel Visual Basic for Applications (“VBA”) (Microsoft and Excel are trademarks of Redmond Wash. Based Microsoft Corporation). In general, VBA is an event-oriented software, meaning that modules of code are called in response to user actions. For example, when a user presses a button, there is a piece of code that runs automatically. After that piece of code runs, the program will wait for the next user event. However, any suitable programming language or architecture can be used.

System 100 can also include a computer aided design (“CAD”) program 135 with an associated CAD database 140 of components. CAD database 140 can include data for components corresponding to components and other parts represented in design data 130. According to one embodiment, design program 125 can output information to CAD program 135 to allow CAD program 135 to draft a diagram of a designed flow system. Example CAD programs include AutoCAD, SolidWorks, ProEngineer and other CAD programs.

Although shown as a standalone device in FIG. 1, system 100 may be integrated with and share components with other devices. Additionally, design program 125 and CAD program 135 can be distributed across multiple storage media and can be executed by multiple processors.

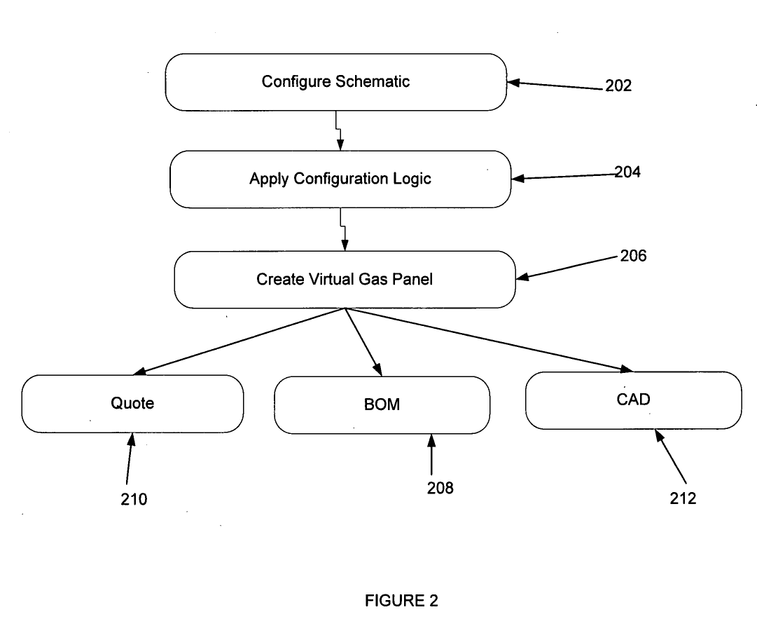

FIG. 2 illustrates the principle steps in designing a fluid delivery system. First, a user configures a schematic in design program 125 (block 202). Design program 125 allows a user to input a schematic for a chosen architecture(s) or in an architecture independent manner. Example architectures include C-Seal, W-Seal, K1S, Intraflow, IGC2 and other gas panel architectures known or developed in the art. Design program 125 processes the input using its configuration logic (block 204) to create a virtual gas panel (block 206). The virtual gas panel design can be output as bill of materials (“BOM”) (block 208), price quote (block 210) or CAD output (block 212).

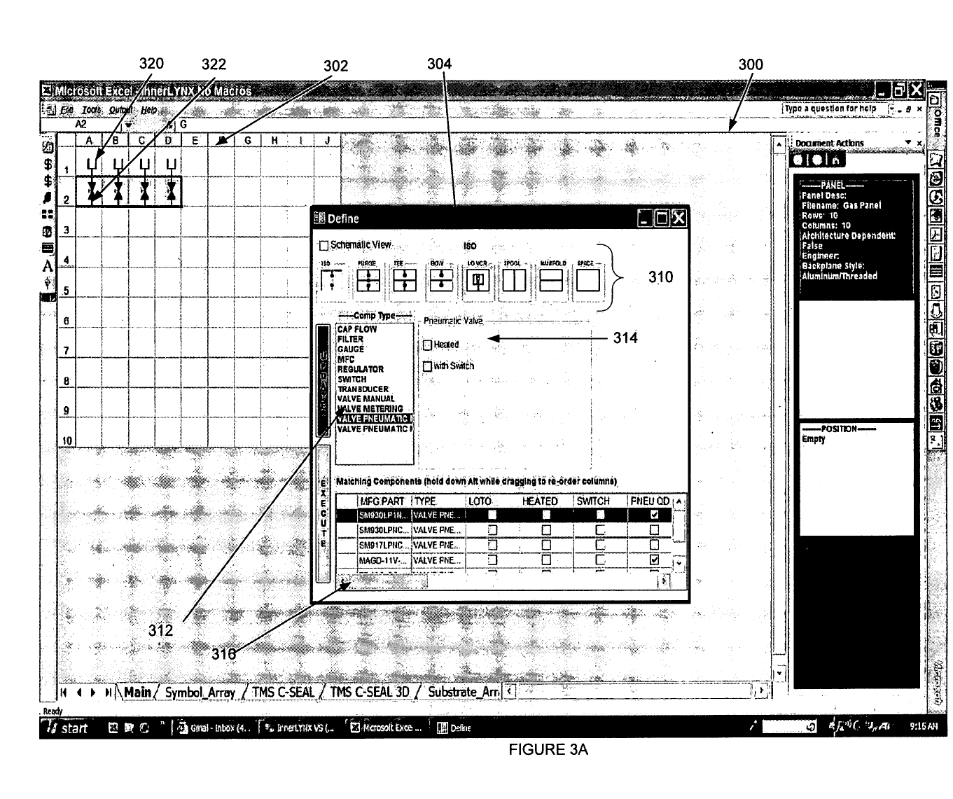

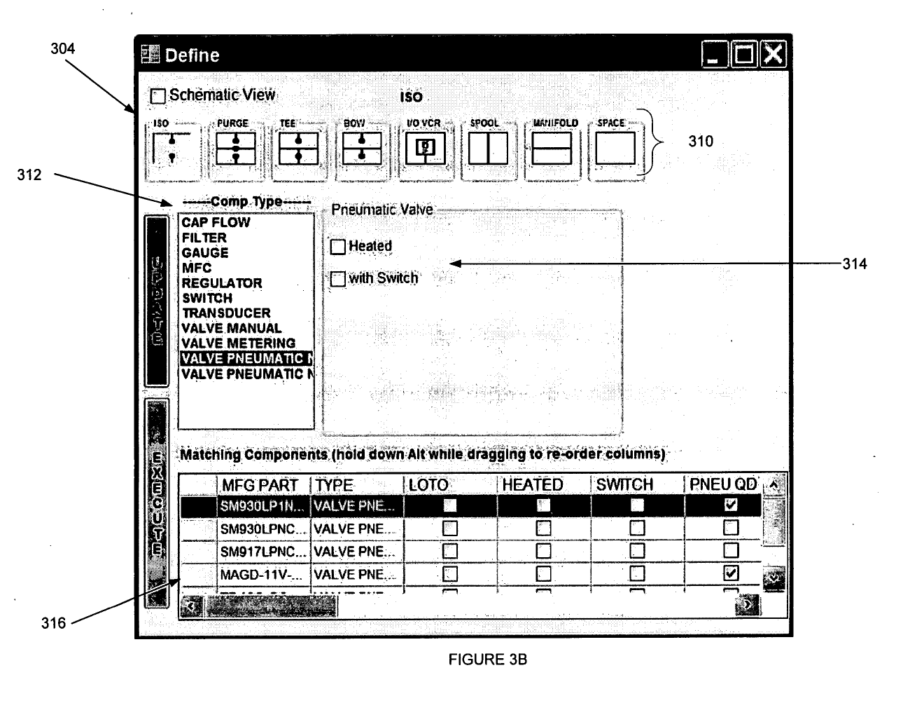

Design program 125 provides a GUI that allows a user to specify various qualities for the flow routing layer, component layer and manifold layer of the gas panel in an architecture independent manner. FIGS. 3-7 below describes one embodiment of designing a virtual gas panel. In the embodiments below, it is assumed that the user has not selected a specific architecture. However, it should be understood that design program 125 can allow a user to select a specific architecture. Selection of a particular architecture can limit the choice of components that a user can select to components compatible with the particular architecture.

FIG. 3A is a diagrammatic representation of a screen shot 300 for providing information related to the flow routing and component layers of the gas panel. Shown in screen shot 300 is a schematic grid 302 and “define form” 304. FIG. 3B is an enlargement of define form 304 of FIG. 3A. Schematic grid 302 allows a user to select a location in a schematic. For a selected grid location, define form 304 provides various options for defining flow functionalities and component qualities, as discussed below. In the embodiment shown, components in a single column of schematic grid 302 are considered a gas stick with the inlet to each gas stick being defined in the topmost row of the column for that gas stick.

According to one embodiment of the present invention, a user defines flow functionality (e.g., fluid routing information) and the component type for a grid location in the schematic by selecting that grid location in schematic grid 302. For example, to define the flow functionality and component type for grid location A2, the user can select A2 (e.g., by clicking on A2) in schematic grid 302 and select the flow functionality and component type in define form 304.

The flow functionality for a grid location is selectable using flow functionality buttons 310. Example flow functionalities include isolation, purge, tee, bow, inlet/outlet (e.g, “I/O VCR”), spool, manifold and space. For isolation, the inlet is isolated from the outlet by a component. Purge is similar to isolation, but a second outlet leads to a manifold to purge fluid. The bow flow functionality includes either the inlet or outlet also connected to the manifold. The I/O flow functionality defines an inlet or outlet, the spool functionality connects two components in the same gas stick, the manifold functionality connects components across gas sticks and space indicates an undefined area in the schematic. Thus, the flow functionality defines the flow routing. These flow functionalities are understood by those in art.

Although not shown, when a user selects a particular flow functionality, the user may be given various choices for the configuration of that flow functionality. For example, if the user selects bow, the user can select whether the inlet or outlet of the associated component connects to the manifold. Additionally, for various flow functionalities, the user can specify parameters. For example, for an I/O functionality, the user, according to one embodiment, can specify the length of the inlet stub or other feature of the inlet (e.g., male or female connector).

Design data 130 can include a correlation (e.g., through arrays, tables or other data structures) between flow functionalities and component types. When a user selects a flow functionality, a component type menu 312 provides a list of component types available for the selected flow functionality (or other options available for the flow functionality). In the example of FIG. 3, the user has selected the isolation (“iso”) flow functionality, so the component type menu 312 provides a listing of component types available for the iso flow functionality. These include, by way of example, “cap flow”, gauge, mass flow controller (“MFC”), regulator, switch, transducer, valve-manual, valve-metering, and valve-pneumatic (various types). These various component types are known in the art as they represent classes of physical components used in fluid delivery systems. As new component types are developed, they can be added to design data 130.

The user, in this example, has chosen a pneumatic valve (represented by the fact that the pneumatic valve is highlighted in component type menu 312). Options for the selected pneumatic valve component type are represented in an option menu 314. In this example, the user can choose to specify that the pneumatic valve must be heated or include a switch.

Based on the component type and options specified, design program 125 will search design data 130 and display a list of available components in component menu 316 that meet the input criteria specified by the user. The user can choose a particular component or allow design program 125 to choose a component in later steps. Component menu 316 displays the manufacturer, part number and options for each component meeting the flow functionality, component type and options specified by the user.

Choosing a particular component may limit the fluid delivery system to a specific architecture as particular components (e.g., manufacturer and part number) are usually compatible with only one architecture. If the user does choose an architecture dependent component for one grid location, design program 125 can limit a user's subsequent design choices to that architecture. For example, if the user chooses a component that is only compatible with the C-Seal architecture for grid position A-2, design program 125 can assume that the user wishes to design a C-Seal gas panel. Consequently, if the user subsequently selects grid location A-3 and specifies a flow functionality of iso and component type of MFC, design program 125 will only present MFC components in component list 316 that are compatible with the C-seal architecture. According to other embodiments, the user can select, for example, the manufacturer of a component without selecting the specific part. Design program 125, in later steps, can then use this information when designing the virtual gas panel.

When the user has finished defining the flow functionality and component type (and optionally specifying a component or some desired quality of the component), the appropriate schematic symbol is placed in the corresponding grid location in schematic grid 302. In the example shown, two rows of component types are defined in schematic grid 302. Each defined component type in the first row is an input (see, e.g. input 320). Each defined component type in the second row is a pneumatic valve (e.g., valve 322).

Schematic grid 302 and define form 304 can provide a variety of user friendly functionality such as copy, “cut and paste” and other such functionality. Additionally, if a user wishes to provide the same design information for multiple grid locations, the user can select the various grid locations and enter the information for the selected grid locations in the define form. For example, in FIG. 3, the user has chosen to define the same flow functionality and component type for each grid location in the row A2-D2. It should be noted that a grid location generally translates into a relative position of components. The flow routing layer, however, may require multiple substrate blocks or parts to achieve particular flow functionality for a grid location. Moreover, the positions of components are relative to each other as various physical components may have different sizes.

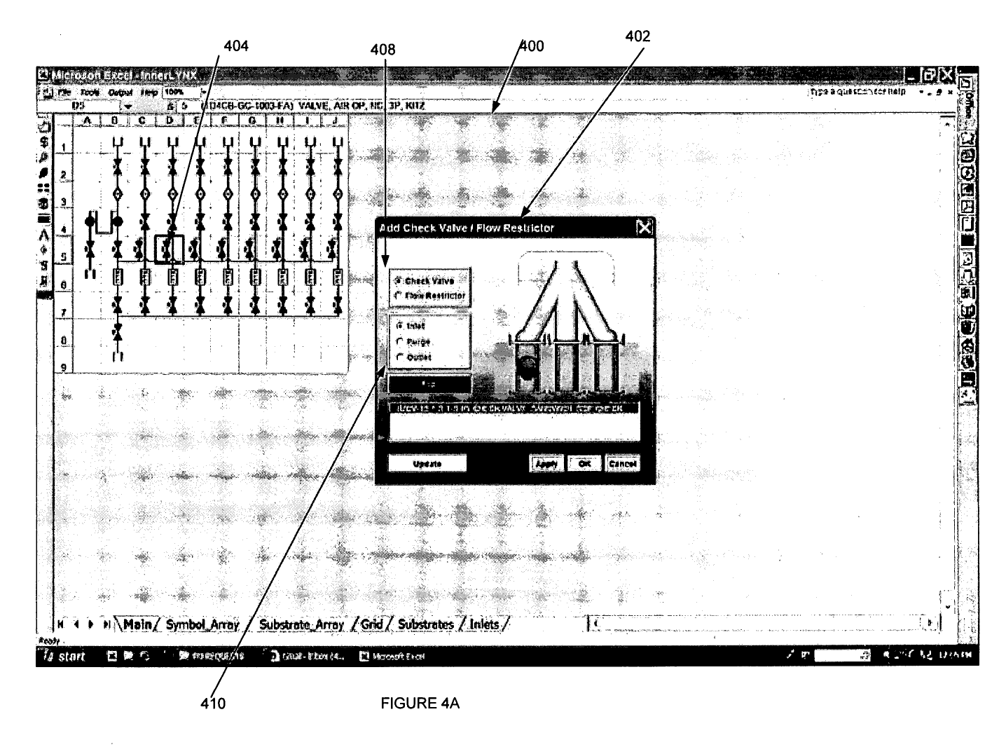

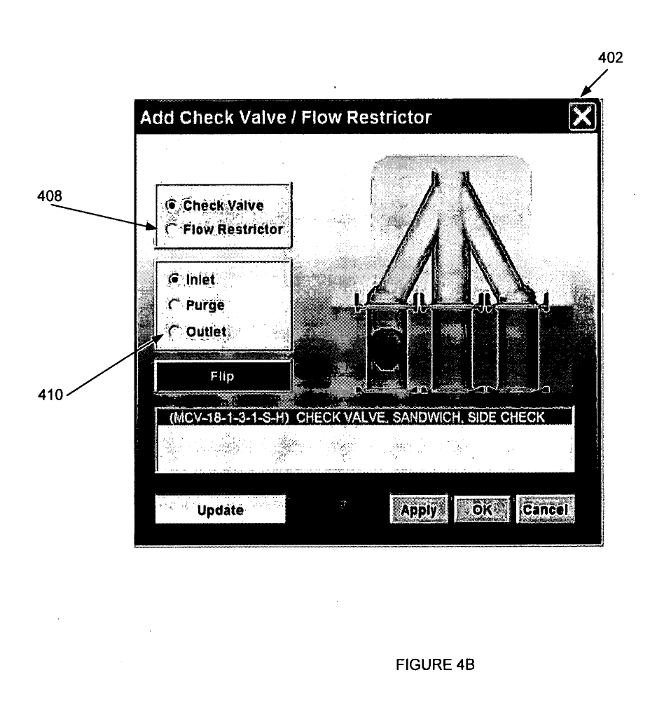

For a grid location, the user can also define a sandwich component type (e.g., a component type for a component that sits between a substrate block and another component). Example sandwich component types include check valves, filters and other sandwich component known in the art. Thus, for a particular grid location, both a sandwich component type and another component or component type can be defined. Defining a sandwich component is illustrated in FIG. 4a, which provides a screen shot 400 that provides a sandwich component form 402 for the schematic grid that allows the user to define a sandwich component for a location. FIG. 4b is an enlargement of the sandwich component form 402 of FIG. 4a. Sandwich component form 402 can be accessed, by way of example, by right-clicking on a grid location and selecting a “sandwich component” option from a drop down menu. In the example shown, the user has chosen to define a sandwich component at grid location D5. The sandwich component, in this case, is a check valve (indicated at 408) on inlet side (indicated at 410) for the pneumatic valve defined in grid location D5 (shown at 404 of FIG. 4a).

When the user has finished the schematic with respect flow functionalities and desired component qualities (e.g., component type and any additional qualities specified for the components), design program 125 has sufficient information to apply its configuration logic to determine flow routing parts (e.g., substrate blocks) and components. For the sake example, selection of substrate blocks will now be discussed. However, it should be understood that selection of substrate blocks or components can wait until the user has provided a manifold specification or heater specification, as discussed below. One reason for determining substrate blocks at this point, however, is to allow a depiction of the substrate layer to be displayed in the GUI to aid the user in defining manifolds and heaters.

For each architecture, design data 130 can include an n-dimensional array for selecting the appropriate substrate block. The n-dimensional array for an architecture can be stored as one or more tables. For a 2 dimensional array, only one table is needed. Additional tables can be used for arrays having 3 or more dimensions. One advantage of this software architecture is that new fluid delivery system architectures can be added by adding new arrays and a minimum or no of reprogramming of existing configuration logic code. An additional advantage is that the arrays can be saved as Excel (or other spreadsheet) tables. This allows for easy modification of array entries.

As an example, assume the choice of substrate block for a particular architecture depends on the flow functionality of the corresponding grid location and the flow functionality of the upstream grid location and downstream grid location. In this case, a three dimensional array is used, stored as two tables. The first table can correlate the flow functionalities of a grid location with flow functionality of the upstream grid location, with the intersections of the flow functionalities providing a key to the second table. The second table can be an array of keys from the first table and flow functionalities. For a particular schematic grid location, design program 125 can find a key to the second table using the flow functionalities of that selected grid location and the upstream grid location. Using the key from the first table and the flow functionality of the downstream grid location, design program 125 can select the appropriate substrate block using the second table.

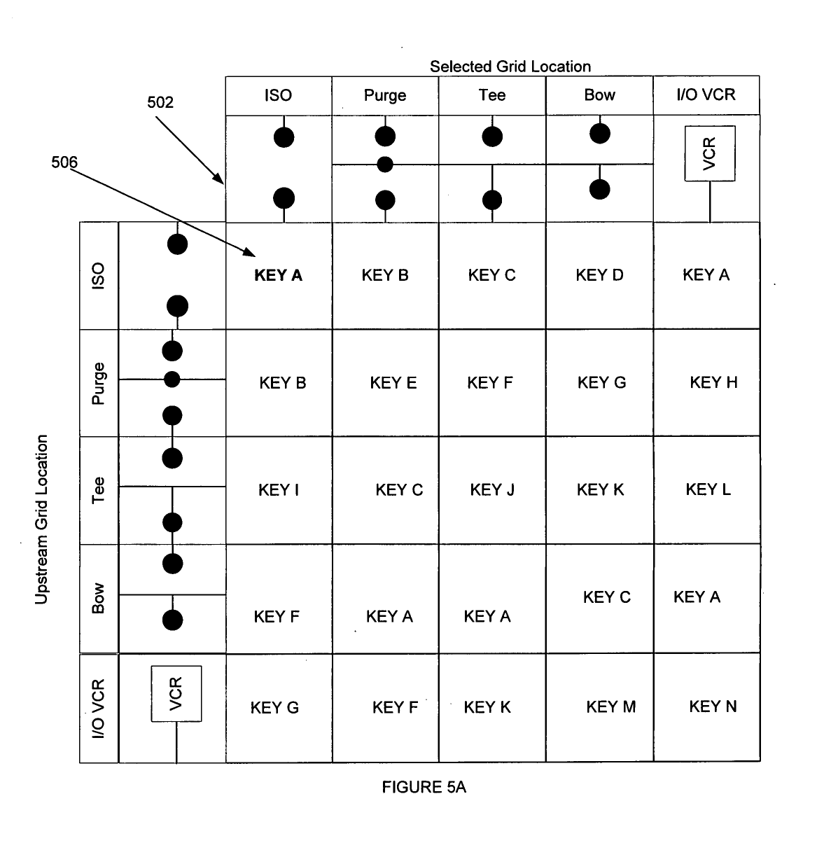

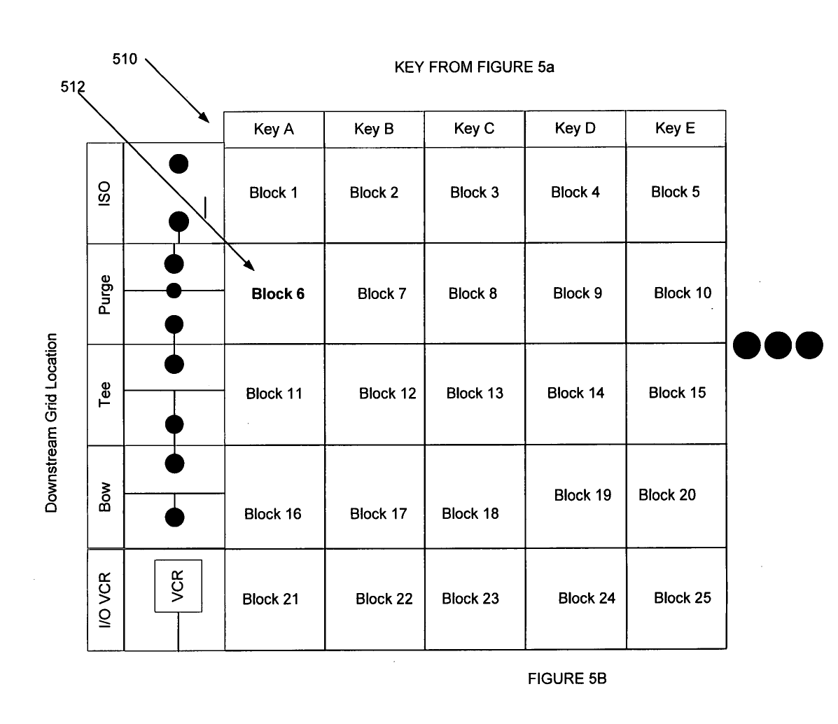

FIG. 5 provides a diagrammatic representation of searching tables of an n-dimensional array to select a substrate block. For the sake of example, assume three contiguous flow functionalities in a column are defined as isolation, isolation and purge and assume that design program 125 is determining the appropriate substrate block for the middle grid location (i.e., the second isolation position). Table 502 is the flow functionality of a selected schematic grid location (x-axis) versus the flow functionality of the upstream grid location (y axis) (in this example only five flow functionalities are shown, however an array can include more or less columns and rows). Each intersection provides a key to the second table 510.

For example, if a selected grid location has a flow functionality of iso and the flow functionality of the upstream location is also iso, “key A” (represented at 506) is selected. The second table correlates substrate blocks to the keys from table 502 (x axis) with the flow functionalities defined for the adjacent downstream location (y-axis). In this example, key A from table 502 and the downstream flow functionality of “purge” are used. Consequently, substrate block 6 is selected (represented at 512). Substrate block 6 will correspond to a physical substrate block for the corresponding architecture.

As another example, if a selected grid location has a flow functionality of purge, the upstream location has a flow functionality of tee and the downstream location has a flow functionality of iso, substrate block 3 will be selected (e.g., key C will be selected from table 502 and block 3 from table 510). If a substrate block cannot be found for a particular location, design program 125 can return an error. For other architectures, design program 125 may only evaluate a single position or multiple positions in the schematic to determine the appropriate substrate block for a particular location (e.g., if there are nine positions in a particular stick, the program may review all nine positions through multiple arrays to determine the substrate block for the first position). It should be further noted that for a particular grid location and flow functionality, an architecture may require multiple substrate blocks (i.e., there is not necessarily a one-to-one correspondence between positions in the schematic grid and substrate blocks). In some architectures, the flow functionality may require other flow routing parts than substrate blocks or in addition to substrate blocks (e.g., tubing parts) or other flow routing and associated parts.

As another example, design program 125 can determine from design data 130 whether a component type selected for a grid location is sensitive to orientation (e.g., inlet/outlet port positioning). For these locations, design program 125 can determine the underlying substrate block orientation based on the component type selected. The substrate blocks for the remaining schematic grid location can then be selected. Thus, the configuration logic for the flow routing layer may take into consideration qualities specified for the component layer.

Tables 502 and 510 of FIGS. 5A and 5B are provided by way of example for a hypothetical architecture. The number of criteria required to select a substrate block can vary from architecture to architecture. Consequently, the tables of selection array can include more or less columns, and various tables of the same array may have different sizes. The selection array can represent any criteria used for selecting a substrate block for a particular architecture. Thus, for each architecture, design program 125 can, according to one embodiment, maintain an n-dimensional array (where n can vary across architectures) representing criteria for selecting substrate blocks for the architecture.

Arrays, or other data structures, can also define rules as to which components can go where. A similar array search can be used to select components for a schematic grid location based on the component qualities and positional information specified by the user. According to another embodiment, design program 125 can search a database of components to select components that have the qualities specified by the user (e.g., iso, pneumatic valve) compatible with each architecture.

If more than one substrate block (or component) works in a particular location, design program 125, according to one embodiment of the present invention, can generate multiple panels. If there are multiple components or substrate blocks suitable for multiple schematic grid locations, however, this can lead to a large number designs, even for a single architecture. Therefore, design program 125 can apply some selection logic to reduce the number of designs. This selection logic can include selection of substrate blocks or components based on any arbitrary criteria, such as price, size, manufacturer or other criteria that can be evaluated from design data 130.

Thus, design program 125 can determine various possible panel configurations (e.g., substrates and components) for multiple architectures or a single architecture. For example, for a particular architecture, design program 125 can look at any array of substrates for that architecture to determine the substrate blocks to be used for flow functionality in relation to the flow functionalities of adjacent blocks and/or the components types that go on the substrate block(s). Additionally, design program 125 can select the specific component that fits the component type and positional functionality. To the extent -multiple components and substrates work for a particular schematic and architecture, design program 125 can produce multiple fluid delivery system designs. To the extent the user has selected a particular component manufacturer for a component, design program 125 will only return results that use that component manufacturer for the component, thereby limiting the results for each architecture. Design program 125 can apply this process to any number of architectures or to a user selected architecture. Thus, design program 125 can return gas panel designs for the C-Seal, W-Seal, K1S, IGC2 and Intraflow architectures (and other architectures known in the art) or limit the results to a selected architecture, say W-Seal.

Again, as described earlier, it is not necessary for design program 125 to determine substrate blocks and components prior to the defining a manifold specification and heater specification. However, choosing substrate blocks (or other flow routing parts) allows an image of the flow routing layer to be displayed to the user to aid the user in specifying manifolds. For the sake of example then, it is assumed that design program 125 does select the substrate blocks prior to the user defining a manifold and heater systems.

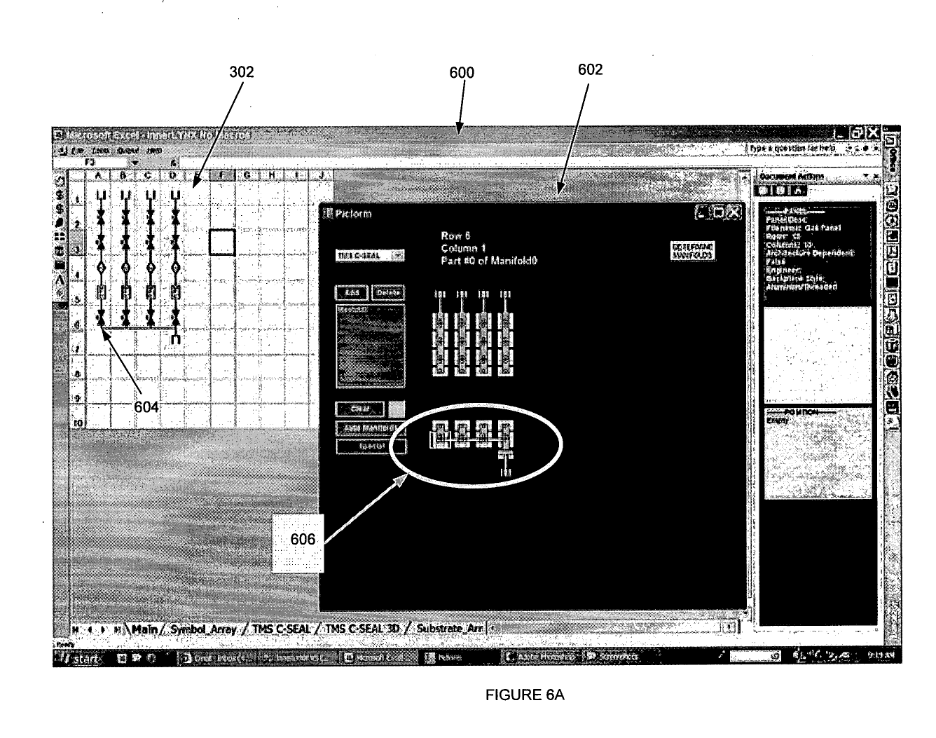

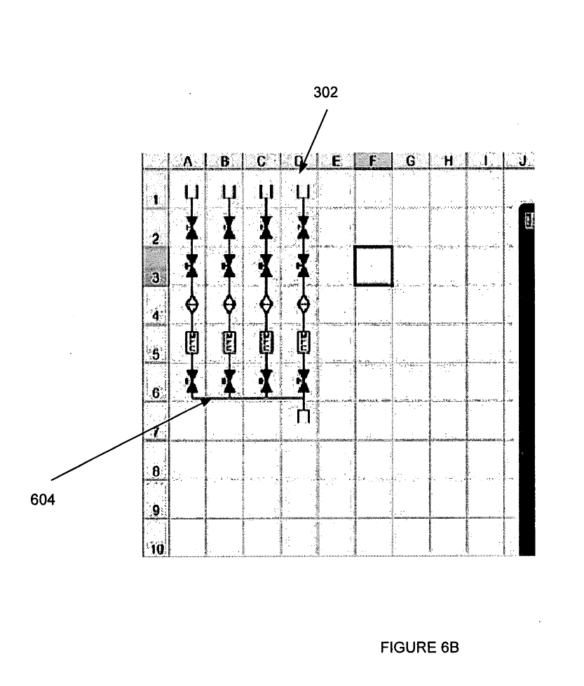

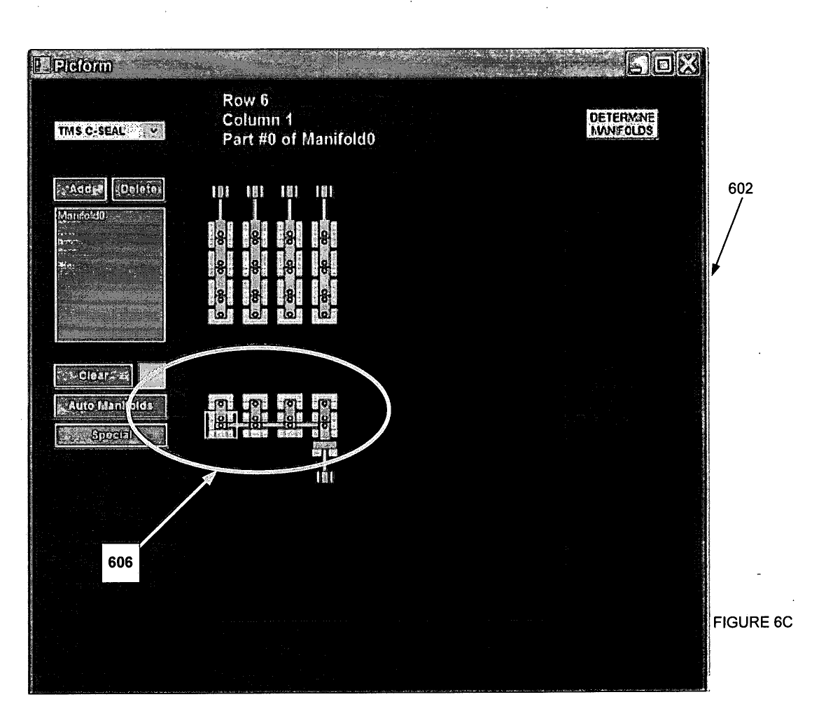

FIG. 6A is an example screen shot 600 for defining a manifold (i.e., the system that routes flow between gas sticks) in which substrate blocks have already been selected. Shown in screen 600 are a completed schematic in schematic grid 302 and a manifold define form 602. FIG. 6B provides an enlargement of schematic grid 302 and FIG. 6C provides an enlargement of manifold define form 602. As the substrate blocks have already been selected by design program 125, as described above, manifold define form 602 can show a pictorial representation of the selected blocks. In this case, the blocks are shown for a panel design in the TMS C-Seal architecture. The user may also select other architectures for which the substrate blocks (or other flow routing parts) were determined.

Comparing manifold define form 602 to schematic grid 302, the components and substrate blocks shown in the first (leftmost) column in define form 602 correspond to the gas stick defined in column A of the schematic gird 302. Thus, manifold define form 602 shows a VCR connector for the I/O VCR connector in grid location A1 and the substrate block to which the I/O connector is attached. Additionally, manifold define form 602 shows the substrate blocks for the valves and other components in the gas stick of column A1. The large darker area that appears empty between the fourth substrate block and fifth substrate block in the leftmost gas stick of define form 602 accounts for the fact that the MFC in grid position A5 is relatively large (i.e., there is some distance between the substrate block that provides an inlet to the MFC and the substrate block that provides an outlet to the MFC).

In general, substrate blocks in a column of schematic grid 302 are connected together by various gas flow components or spools to form a gas stick. Substrate blocks (or components) are connected across gas sticks by manifolds. As shown in FIGS. 6A and 6C, the user can select several substrate blocks to link together by a manifold. In this example, the user has chosen to link A6, B6, C6 and D6 (represented by the flow passage connecting the corresponding substrate blocks in the circled region 606 of manifold define form 602). This is represented in schematic grid 302 by the line 604 connecting each of these grid locations and in manifold form 602 by the tubing running between the lowest row of substrate blocks. Thus, each gas stick is connected to the common outlet defined at schematic location D7.

The physical manifolds corresponding to the manifolds defined in manifold form 602 can vary between architecture. For example, in the case of the K1S architecture and Lynx architecture, the manifolds are flange pieces welded together to form a weldment. Other architectures, such as IGC2, utilize a two layer modular platform in which manifolds are assembled in much the same way as gas sticks (i.e., using an additional layer of modular blocks). In these architectures, the manifolds are routed through an additional layer of blocks beneath or above the substrate layer. Because of the differences in manifolds across architectures, the user can be given the option to define manifolds in an architecture dependent manifold form 602. According to other embodiments, the user can define manifolds in an architecture independent form.

In some cases, the definition of manifolds may be straightforward and simply require connecting gas sticks in straight lines perpendicular to the sticks (e.g., as shown in manifold form 602). In this case, an automatic manifold determination process can be used. For example, the user can click the “Determine Manifolds” button and design program 125 will automatically determine manifolds. According to one embodiment, design program 125 will review the flow functionalities specified for grid locations. Design program 125 can automatically create the appropriate manifold between grid locations in the same row that have a flow functionality indicating a connection to a manifold.

As an example, a user can specify various versions of the “bow” flow functionality for grid locations A6, B6 and C6 (i.e., so that the outlet of the valves defined for these grid locations are connected to the manifold) and a “tee” type flow functionality for grid location D6. Because each of the flow functionalities in adjacent grid locations of row 6 of schematic grid 302 specifies the use of a manifold, design program 125 can automatically connect the corresponding substrate blocks with a manifold as shown in manifold form 602. Thus, design program 125 can automatically generate a specification for a manifold between grid locations in the same row for which the flow functionality indicates the use of a manifold. Put another way, design program 125 can automatically create manifolds using the specified flow functionalities by connecting sticks in a straight line perpendicular to the sticks.

In other cases, a user may wish to use a “juke” manifold in which a manifold will juke to connect different rows together. In this case, the manifold is defined manually. The user, using manifold form 602, can select the substrate blocks in different rows that are to be connected together using a manifold. Design program 125 can then save the manifold specification provided by the user or automatically determined. The manifold specification essentially details which substrate blocks are connected by a manifold.

It should be noted that manifold form 602 can provide a variety of user friendly features. For example, if the user wishes to define multiple manifolds, manifold form 602 can label the different manifolds using different colors. Manifold form 602 can also provide functionality such as “cut and past”, copy, “drag and drop” and other functionality used in GUIs.

In the foregoing example, the user defines manifolds after substrate blocks have been selected for and architecture. According to other embodiments, the user can define manifolds using, for example, the schematic grid. In this case, the user can select grid locations to be connected together with a manifold. Design program 125 can graphically display the manifold as, for example, a line between grid locations. Thus, for example, the user can select to connect grid locations A6, B6, C6 and D6 with a manifold. This manifold is represented by line 604 in schematic grid 302.

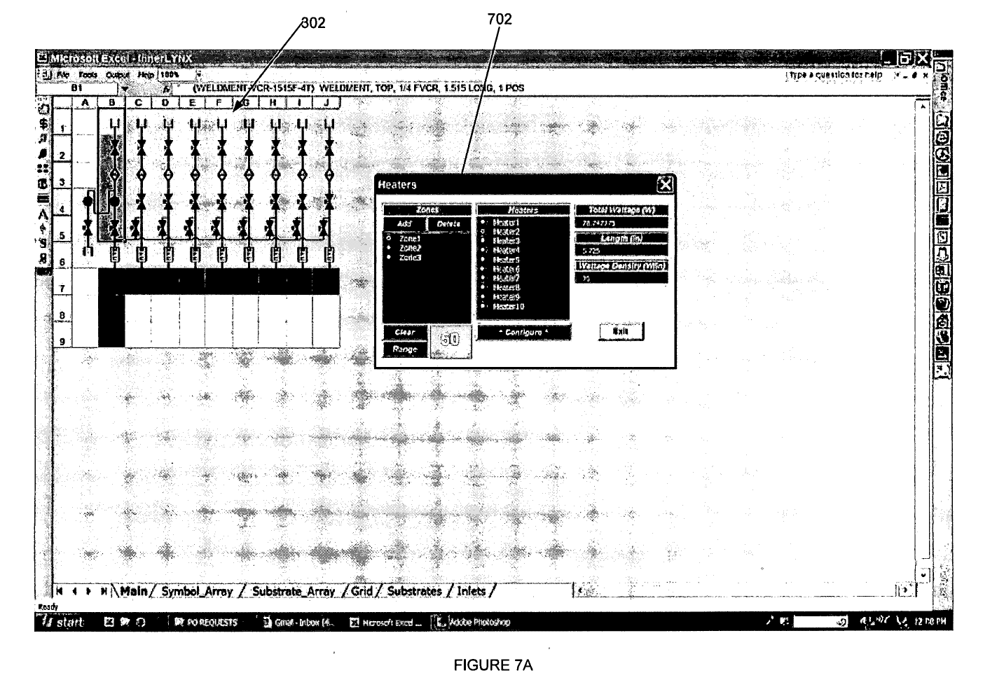

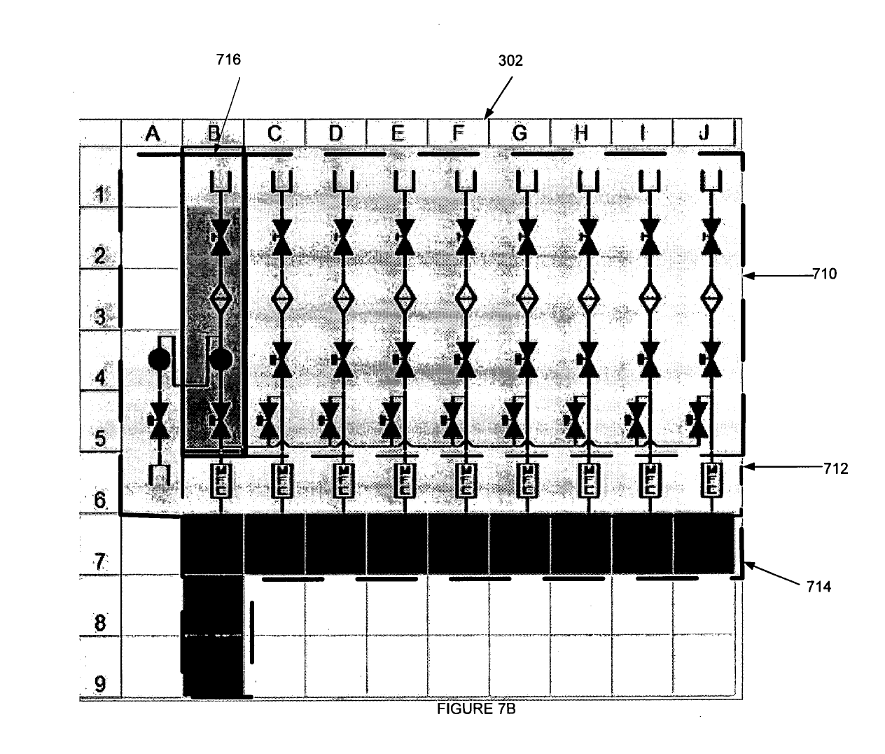

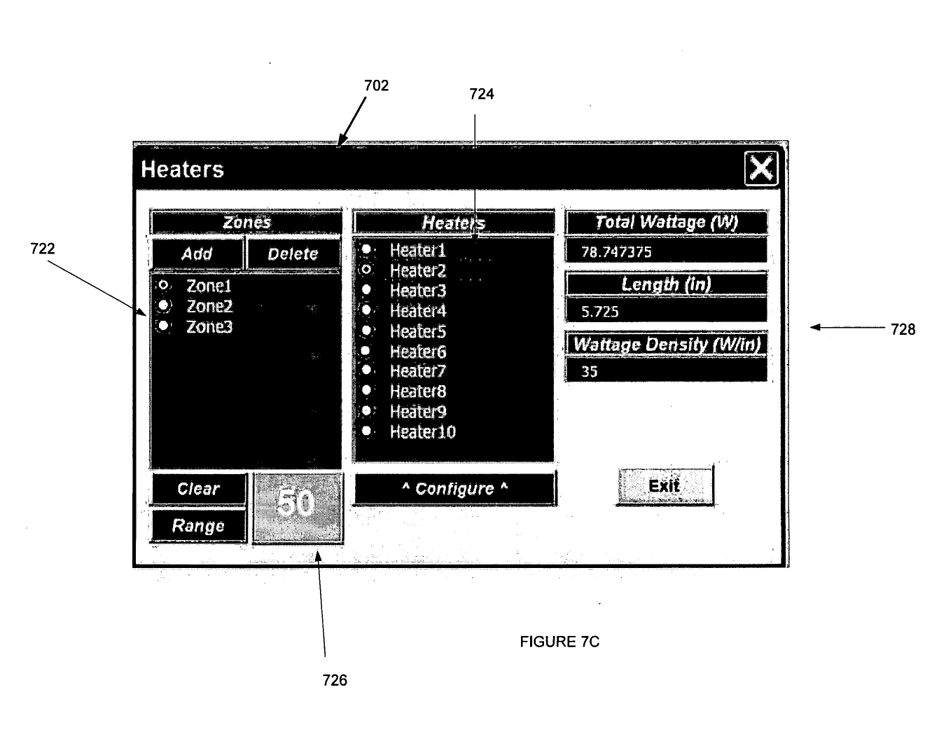

In addition to defining manifolds, a user can define heater systems for a fluid delivery system using, for example, a heater form. FIG. 7A illustrates one embodiment of a heater form 702 for defining heaters for a schematic in schematic grid 302. FIG. 7B is diagrammatic representation of an enlarged schematic grid 302 of FIG. 7A showing temperature zones and FIG. 7C is a diagrammatic representation of an enlarged heater form 702. As shown in FIG. 7B, the user has chosen to define three temperature zones (zone 710, zone 712 and zone 714, delineated by the dashed lines). The three zones are listed at 722 on heater form 702 as shown in FIG. 7C. For each temperature zone, the user can specify multiple heaters. Generally, the heaters are straight line heaters, so a single heater can-heat contiguous blocks in a row or column. For example, for each column in temperature zone 710 (shown in FIG. 7B), the user can define a heater, leading to ten heaters (i.e., one for each column in the zone). This is reflected at heaters list 724 of heater form 702 in FIG. 7C.

A user can select whether a heater is a self limiting or closed loop heater. For a heater, a user can select multiple contiguous grid locations to be in a temperature zone having a specified temperature. As shown in FIG. 7B, the user has selected to define a heater in temperature zone 710 (represented by the selected blocks at 716). This heater corresponds to heater 2 for zone 1 indicated in heater form 702 of FIG. 7C. Using the specified temperature (e.g., 50 degrees as shown in heater form 702 at 726)), architecture and geometry of the temperature zone, the heater can determine the length of heater required and wattage required. This information is shown in heater form 702 at 728.

The length of the heater is based on the length of the corresponding temperature zone. Wattage can be determined by the length of the heater, control type (i.e., closed loop can have a higher wattage than self limiting as the controllers will limit the temperature of the heater) and target temperature. Selection of a heater can be done for each temperature zone. For a closed loop solution, design program 125 can also select thermocouples and a controller for the heater. Generally, the wattage of a closed loop heater can be higher as it is assumed the controller will limit the temperature. For a self-limiting heater, the wattage is limited to the wattage required to achieve a specified temperature. The advantage of self-limiting heater is that the self-limiting heater will not overheat the gas panel if the controller malfunctions.

It should be noted that temperature control in gas panels does not have to be precise as the primary concern is keeping the gas above its condensation temperature and not precisely regulating the temperature of the gas. The factors required to create a heater to achieve a target temperature are understood by those in the art. As new methods of determining heater sizes are developed, they too can be incorporated in design program 125. Again, heater form 702 can include user friendly features such as color coding of temperature zones, “drag and drop”, “cut and paste” and other features.

It should be further noted that the temperature zones can be defined independent of a particular architecture. Thus, while heater form 702 shows defining temperature zones for a specific architecture, the temperature zones may be defined by selecting grid locations on schematic grid 302 or other mechanism.

At this point, all the information to fully determine one or more gas panel designs is known including the flow functionalities, component types, manifold specifications and heater specifications. As described in the embodiments above, the substrate blocks have also been determined for each architecture (or a selected architecture). The user can then choose determine one or more panel designs. According to one embodiment, this can be done using a quote form. Design program 125 can generate a quote using data for the various flow functionalities, component types, substrate blocks, components, manifolds and heaters. If the substrate blocks have not yet been determined, design program 125 can determine the appropriate substrate blocks using one or more arrays as described above. Additionally, design program 125 can determine the appropriate components using similar arrays or a searchable component database. This may lead to the generation of a large number of gas panel designs. Therefore, design program 125 may limit the actual gas panel design outputs to those having the lowest cost components or according to other criteria.

The pricing information for substrate blocks and components can be contained in design data 130 (e.g., as part of a parts database). According to one embodiment, design program 125 can integrate with inventory systems such as Oracle, such that design data 130 is continuously updated with the daily (or hourly or other time increment) prices being paid for parts.

For manifolds, the cost of tubing is generally deminimis compared to the cost of welds and labor. Therefore, the quote for a particular manifold may simply be an estimate for the welds and labor. The estimated labor costs and required welds to connect a particular substrate block to a manifold are generally known from experience. By reviewing the number of and types of substrate blocks (or other parts) to be connected, design program 125 can provide an overall estimate of labor costs and welds for each manifold for a particular architecture. For heaters, design data can include estimates for providing a particular length heater capable of sustaining a required wattage. Again, this information can be known for experience in designing heaters.

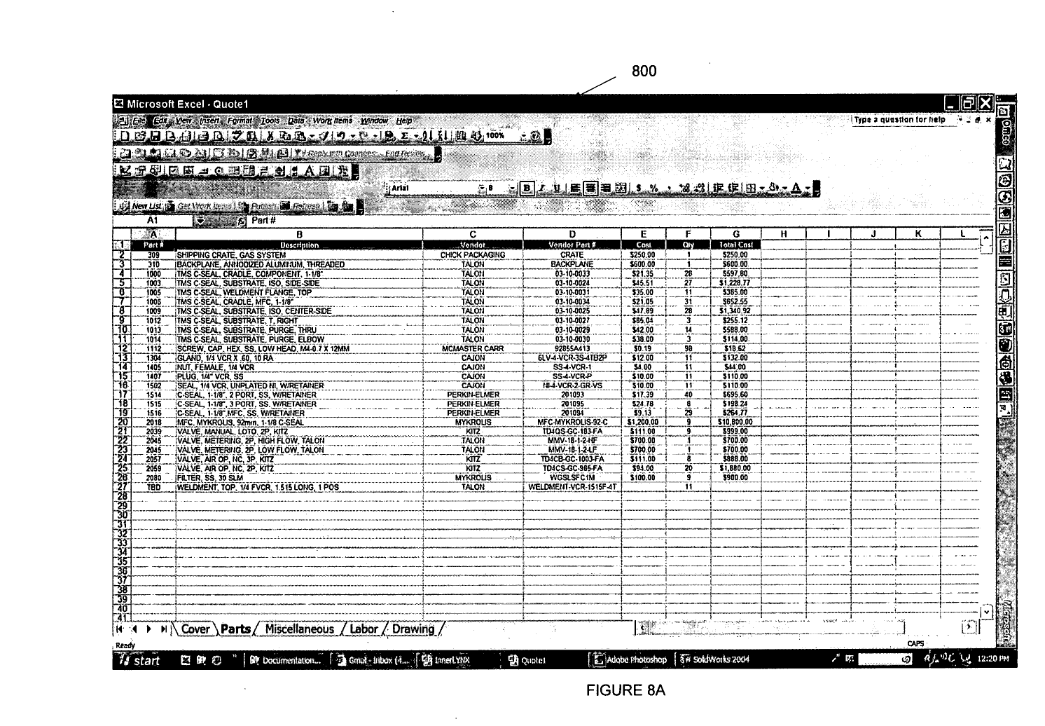

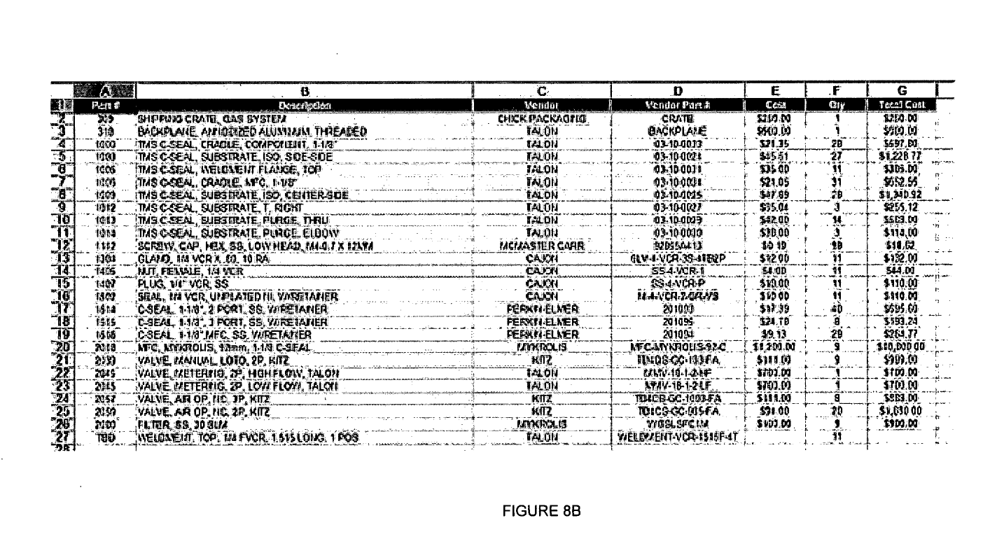

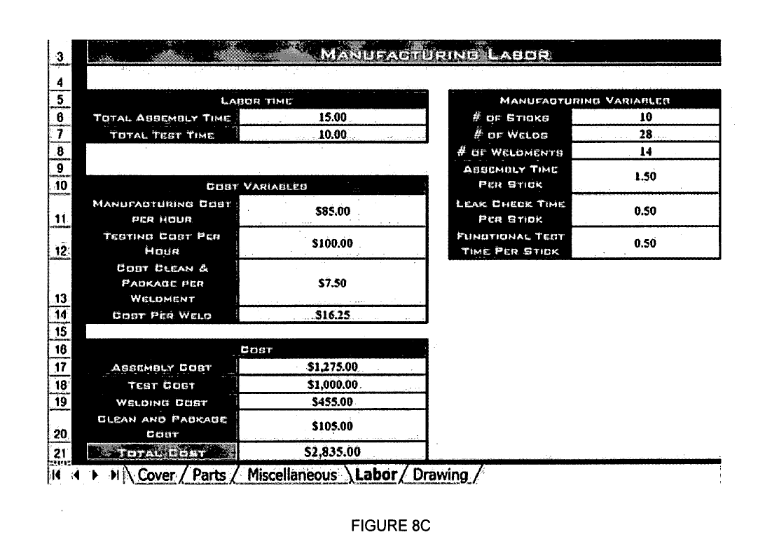

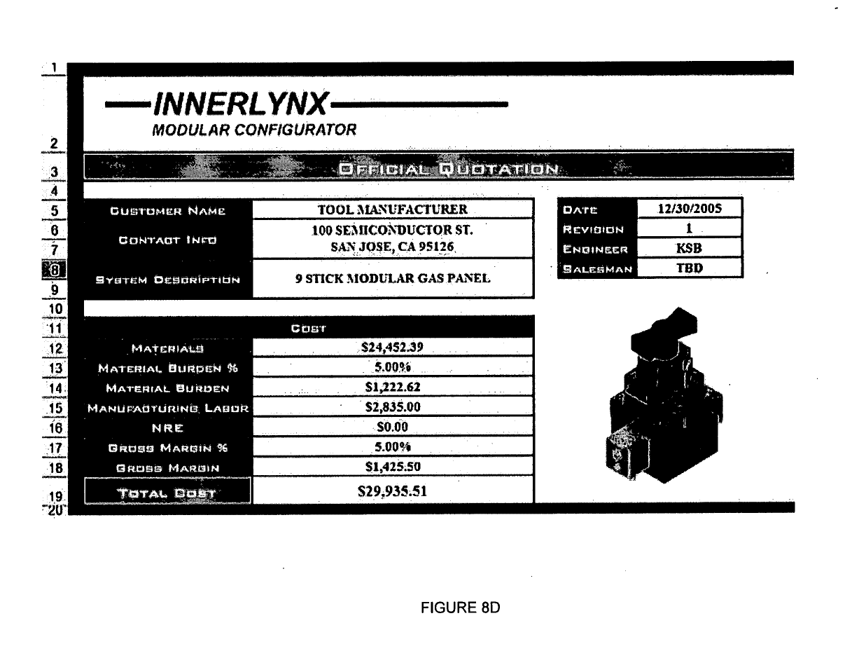

Design program 125 can generate a parts list and quote for panel designs determined by design program 125 that meet the selection criteria, if any. FIG. 8A illustrates one embodiment of a screen shot 800 of an example quote for the TMS C-Seal architecture. Generating a quote can include generating multiple panel designs for a single architecture or for multiple architectures. The parts lists can include all the parts necessary to create a gas panel (e.g., including screws, miscellaneous connectors etc.) and labor costs. This information can be derived from the design data 130 that can include various tables that specify labor costs for connecting parts, parts used in connecting specific components to substrate blocks and other information. Other information can include the shipping crate price, which can be based on the size of the gas panel, non-recurring engineering (“NRE”) costs and other information. FIG. 8B is an enlargement of the parts list and pricing information of FIG. 8s. FIG. 8C illustrates a labor cost quote. The labor costs can be based, for example, on the number of sticks, number of welds, number of weldments, estimated assembly time per stick, estimated leak check time per stick, functional test time per stick, costs of labor and other labor costs. FIG. 8D illustrates a summary screen 804 for the quote of FIGS. 8A and 8C.

For a particular panel design, design program 125 can populate a data array containing the following example information for each corresponding location in schematic grid 302: component type, component manufacturer part number, component angle, ISO, CV manufacturer part number, CV orientation, any manifold parts for that position in the schematic, manifold angle, offset, cradle, weldment port, heater, heater angle, t conversion, t conversion angle. Other data for each grid location can also be maintained.

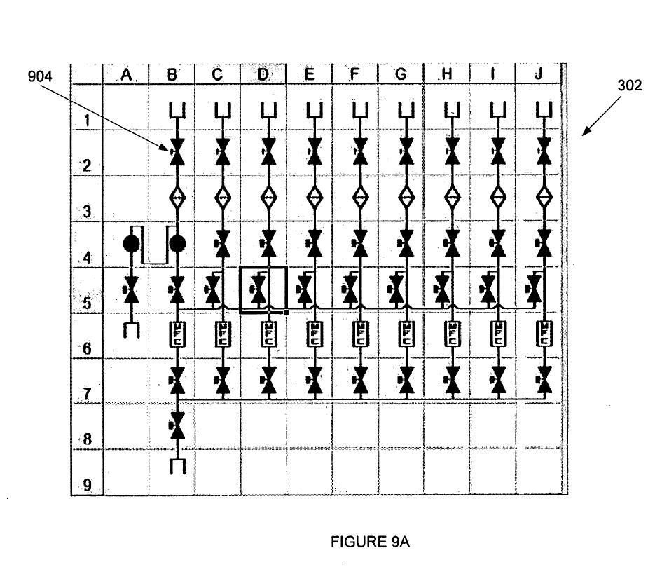

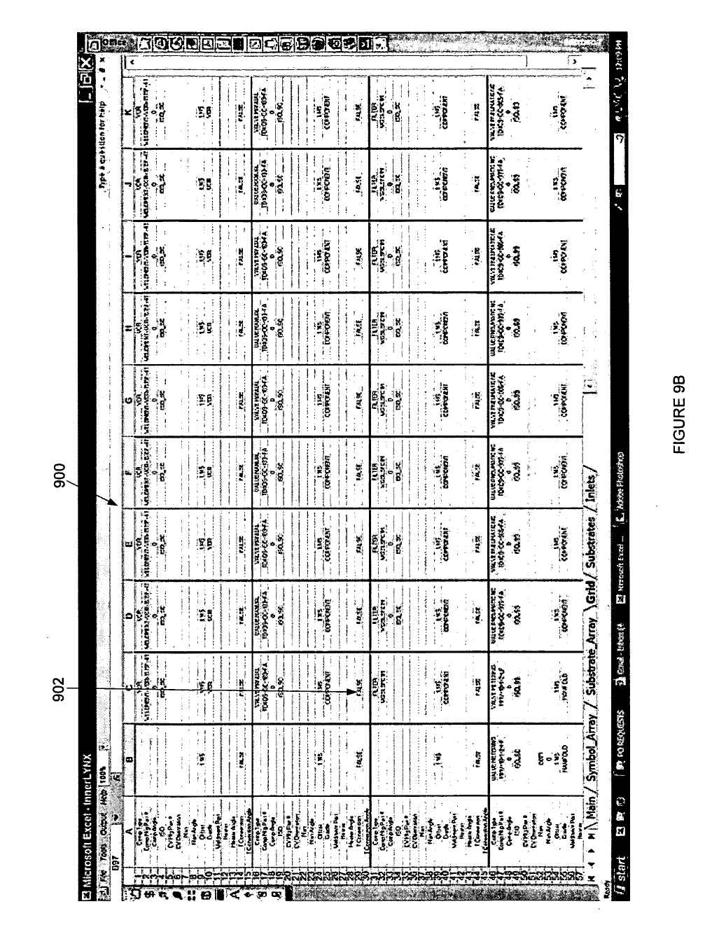

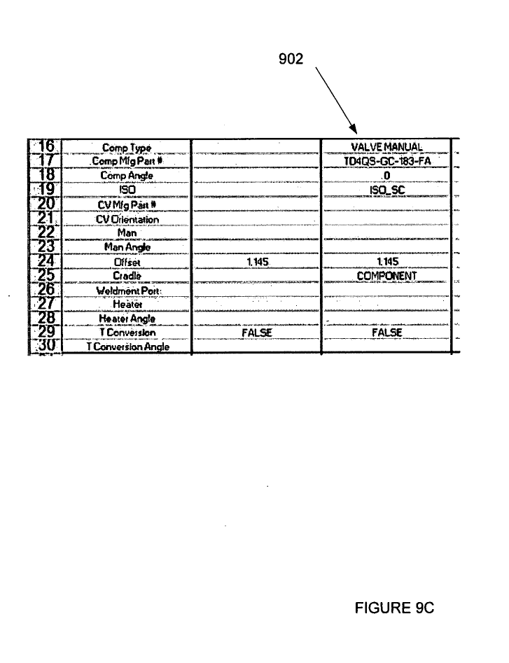

Given the example schematic in FIG. 9A (e.g., as laid out by a user using schematic grid 302), an example layout of a portion corresponding data array 900 is illustrated in FIG. 9B. The data shown in FIG. 9B corresponds to columns A-J and rows 1-4 of the schematic of FIG. 9B. For example, in data array 900 of FIG. 9B, data in column C, rows 16-30 (indicated at 902 in FIG. 9B) corresponds to schematic grid location B2 of the schematic of FIG. 9A (indicated at 904 in FIG. 9A). FIG. 9C is an enlarged version of a portion of data array 900 including column C, rows 16-30 (indicated at 902). The respective rows, as discussed above include:
Component type=Valve Manual
Component Manufacturer Part=TD4QS-GC-183-FA
Comp. Angle=0
ISO=ISO_SC
CV Mfg Part=N/A
CV Orientation=N/A
Man=N/A (i.e., this part does not connect to a manifold)
Man Angle=N/A
Offset=1.145
Cradle=Component
Weldment Port=N/A (i.e., part does not require a weldment)
Heater=N/A (part is not heated)
Heater Angle=N/A
T Conversion=False
T Conversion Angle=N/A

It should be noted the various angles are essentially angles based on the two-dimensional schematic grid. The angles determine the orientations of the various parts. For example if a component at 0 degrees has its inlet at the top of grid location, a component at 180 degrees would have its inlet at the bottom of the grid location. Thus, a simple data array can include information necessary to describe a particular gas panel.

Design program 125 can further output a gas panel design to a CAD program. It is assumed that the CAD program with which design program 125 interfaces (e.g., CAD program 135) includes a CAD database (e.g., CAD database 140) that contains data for the various components and substrate blocks for which a CAD drawing will be made. CAD database 140 may also include data for various manifolds and heater systems.

For a panel design, design program 125 can determine whether it has previously provided a particular manifold specification to the CAD program 135. If not, design program 125 can provide the appropriate specifications for a manifold defined in manifold form 602 (e.g., based on architecture, length of the manifold, and shape of the manifold) to the CAD program. The manifold specifications can be stored in a file (or other data structure) usable by CAD program 135 so that CAD program 135 can generate a part or assembly for the manifold. The new part or assembly can be assigned a name based on the specifications of the manifold part or assembly and added to the CAD database. Similarly, design program 125 can store the specifications for a heater system in a file (or other data structure) usable by CAD program 135. Put another way, design program 125 can add any new manifolds or heater systems to CAD database 140.

According to one embodiment, design program 125 interfaces with CAD program 135 through the CAD program's API. For each component, substrate block, manifold and heater system, design program 125 can provide CAD program 135 a name or other key to allow CAD program 135 to load the appropriate parts from CAD database 140. Additionally, design program 125 can provide an orientation and location for each part. Locations can be provided relative to a set of predefined coordinates or relative to other parts. Generally, positions for various architectures are easily defined based on schematic grid 302 as each architecture typically uses substrate blocks of a known size and the components have known sizes.

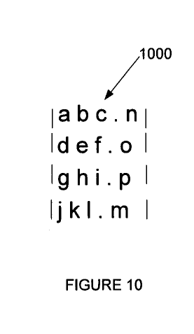

As an example, part positioning can be provided to the SolidWorks CAD program through transformation matrix data. FIG. 10 illustrates one embodiment of a transformation matrix 1000. Transformation matrix 1000 can be stored as a homogeneous matrix of 16 elements, ordered as shown in FIG. 10. The first 9 (a to i) elements provide rotational information, the next three elements (n,o,p) a translation vector and the last (m) a scaling factor j,k, and l can remain unused. Thus, for a particular part, the matrix describes its orientation, position and scale.

The rotational information can be broken down into three rows (a,b,c; d,e,f and g,h,i). a, b and c provide x-axis components of rotation, d,e,f the y-axis components of rotation and g,h,i the z-axis components of rotation. Reflections can be added by setting the values to negative numbers. The rotational information, translation vector and scaling factor creates an affine transformation. For each part in a panel assembly, design program 125 can create the appropriate translation matrix.

To add components to an assembly, SolidWorks is provided with the number of parts to be added, an array of filenames for the parts to be added and an array of component transforms (i.e., as described above). This can be done through the AssemblyDoc→AddComponents (count, names, transforms, retval) method. According to this method, design program 125 can provide an array of file names that represents all the parts that are added to the assembly (if there is more than one instance of a part, the filename for the part should be included for each instance of the part) and an array of transforms includes a transform for each part being added. SolidWorks will then make the assembly and provide a pointer to the newly created assembly (i.e., will provide the retval). It can be noted that in this example, design program 125 assumes that the various parts have already been modeled in CAD and design program 125 is giving the CAD program the information to create assemblies.

According to one embodiment, the CAD program can be presented with data such that each gas stick is considered an assembly and the gas panel is an assembly of the gas sticks (i.e., the gas stick assemblies are subassemblies of the panel assembly). Each gas stick assembly can essentially be considered a part. Consequently, design program 125 can provide information to SoldWorks to assembly the gas stick assemblies and manifold assembly into a gas panel assembly.

Additionally, by providing the CAD program with the manifold information, the CAD program can automatically generate the appropriate manifold assembly. This can include modeling the tubes and weldments used for the manifold. The manifold assembly can be assigned a name and part number. Additionally, design program 125 can add a part number to the inventory system that correlates to the manifold system in the CAD database. A heater can be a generic heater part that is resized the appropriate size based on the heater specification. A new heater can also be saved in the CAD database and assigned a name and part number. Design program 125 can similarly add a part number and other information to the inventory system.

When all the stick assemblies are finished for the panel, Solid Works can draw the backplane of the panel. The backplane of the panel is a part to which the substrate blocks are mounted. Mounting holes are automatically placed depending on the architecture and a drawing of the backplane automatically generated. SolidWorks can then add the various gas stick assemblies, manifold assemblies and heaters to the overall panel assembly.

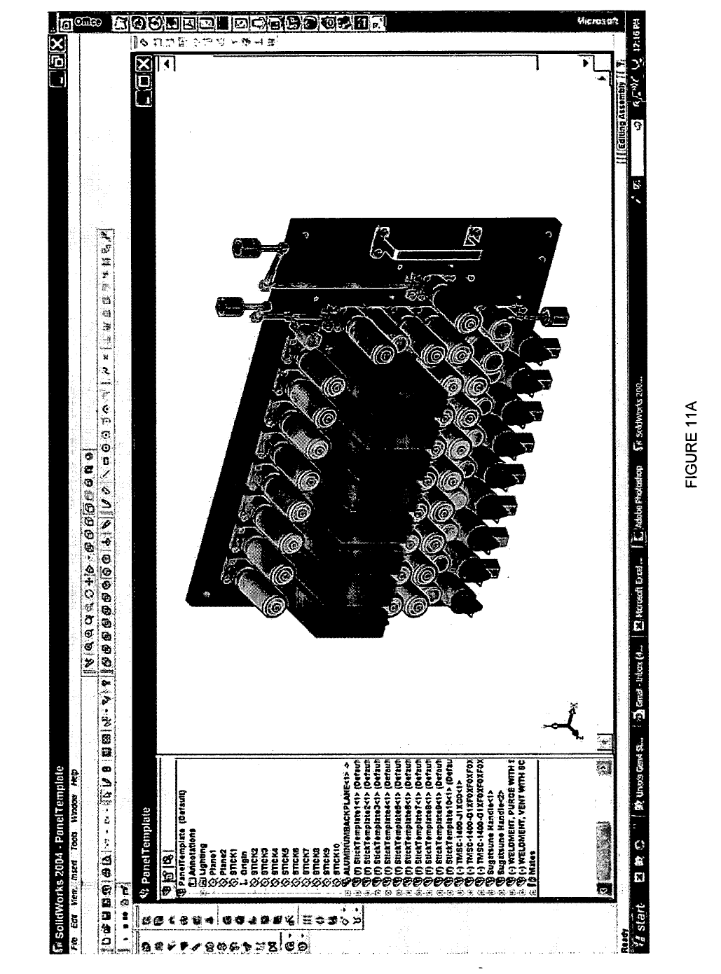

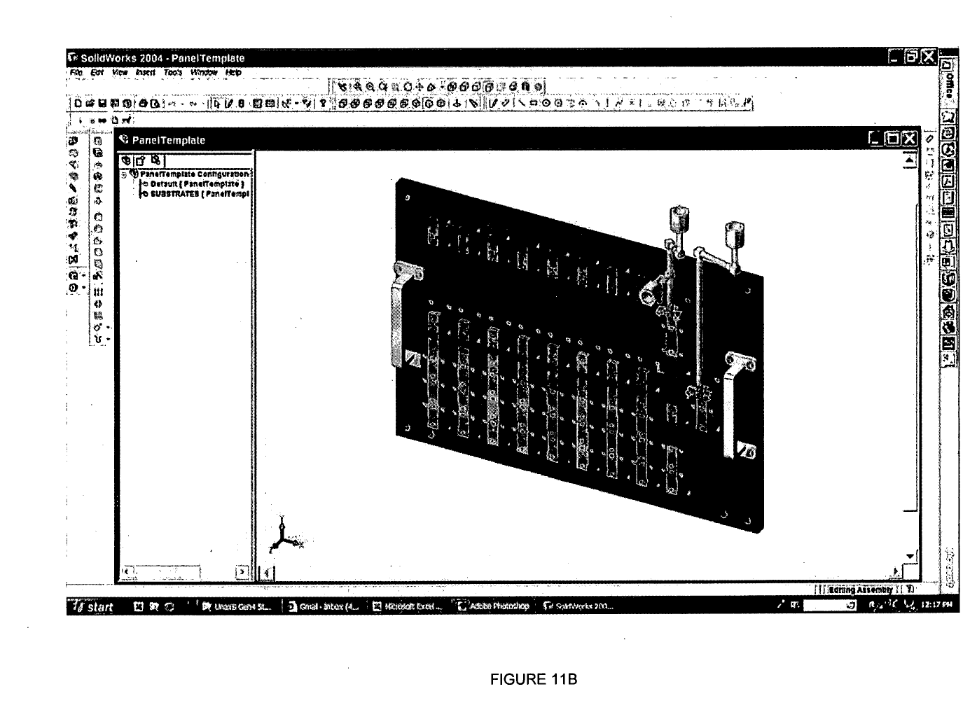

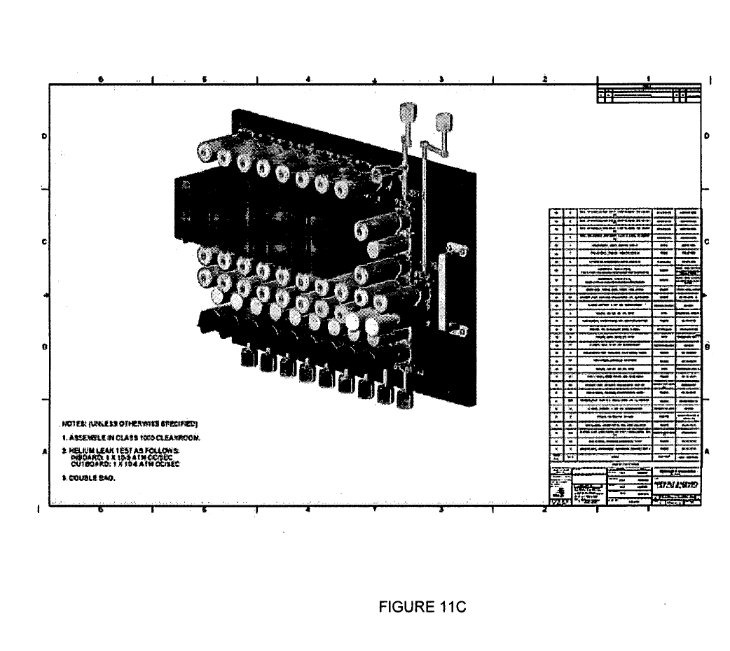

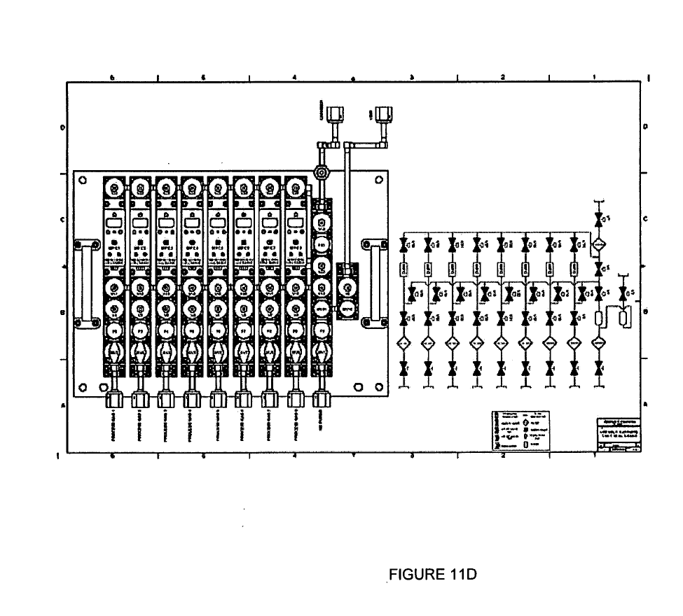

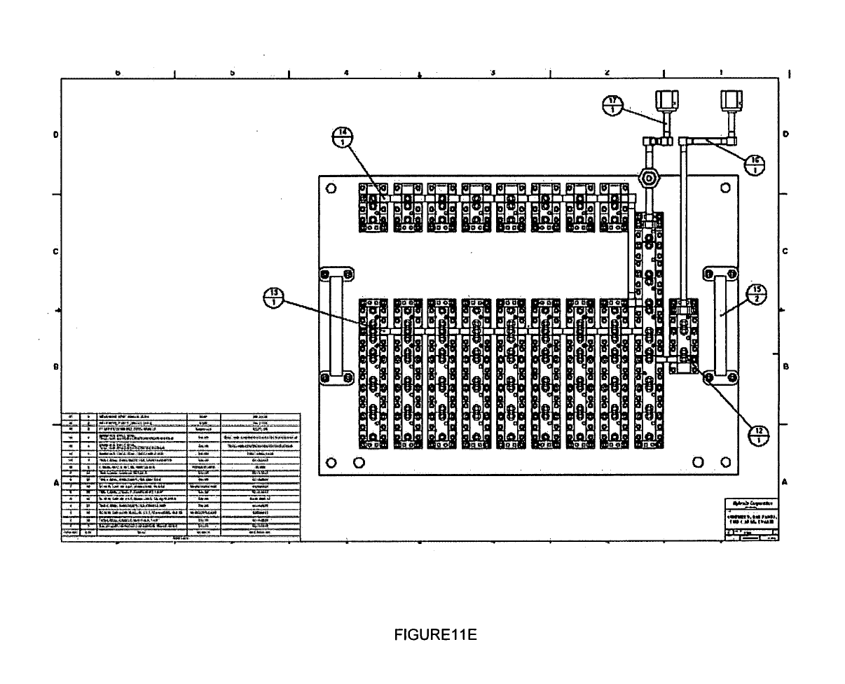

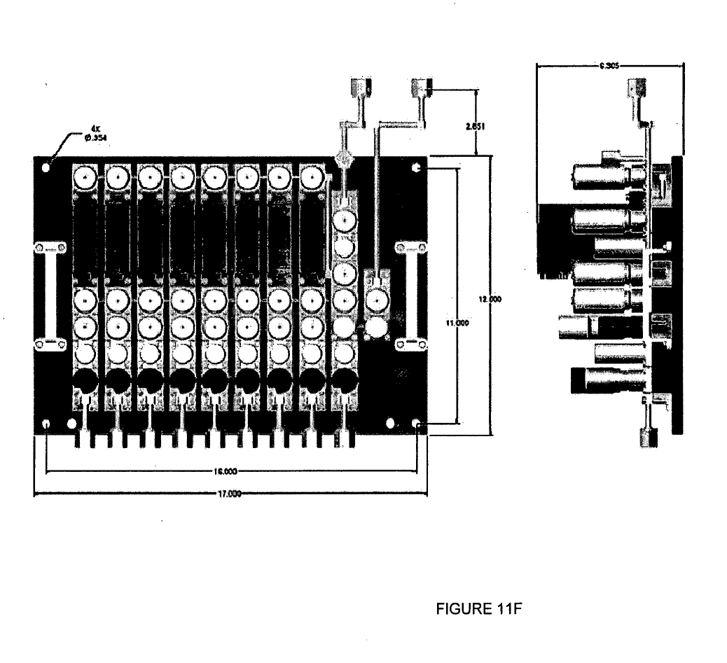

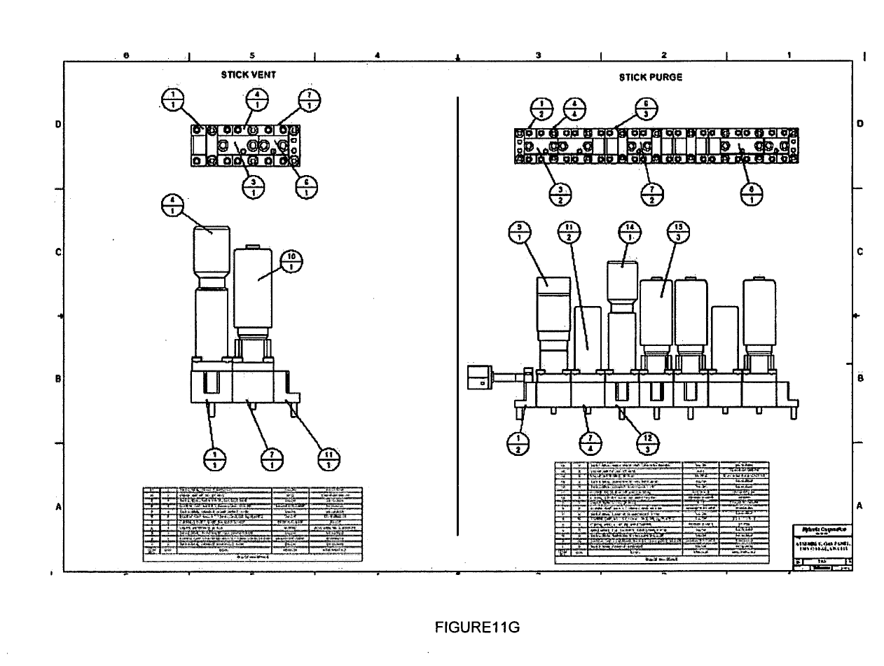

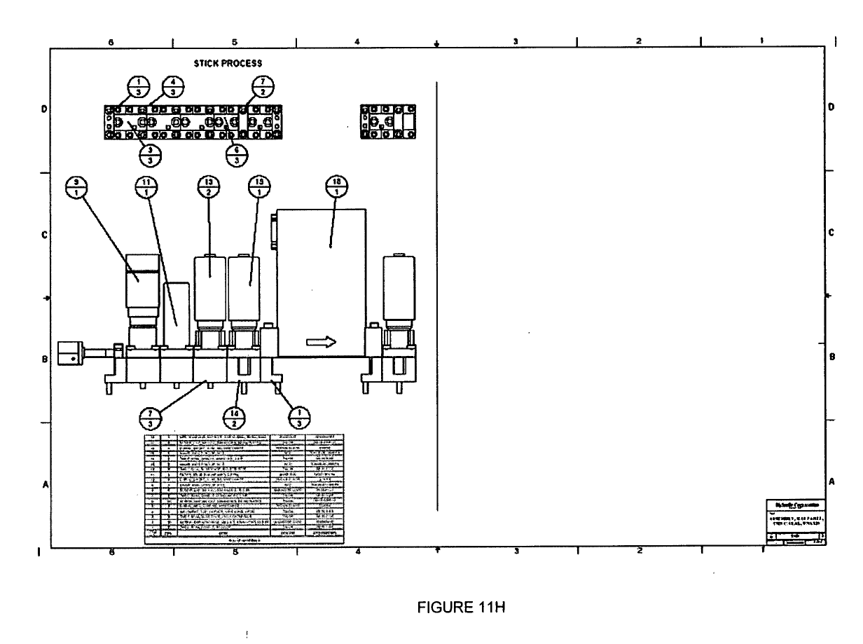

When SolidWorks has completed the full panel assembly, it will begin a drawing. FIG. 11A illustrates one embodiment of panel assembly drawing (e.g., for the schematic shown in FIG. 9A). FIG. 11B shows the same assembly without the component layer. Design program 125 can prompt CAD program 135 to produce various drawings from the gas panel design information provided by design program 125 using mechanisms known in the art for interfacing with CAD programs. FIGS. 11C-11G provide additional example drawings that can be produced by a CAD program. Various drawings that can be generated by the CAD program include, by way of example but not limitation, overall isometric view of the panel with BOM, top view of panel and schematic, top view of panel without components, individual gas stick assemblies, manifold assemblies, backplane parts, shipping crate drawings, schematic drawings and other drawings.

Although primarily discussed in terms of SolidWorks, the same information can be translated for use by other CAD programs (e.g., ProEngineer, AutoCAD, etc.). In the case of ProEngineer, for example, design program 125 can save a text file in a format usable by ProEngineer to allow ProEngineer to render the various assemblies and subassemblies.

It should be noted that in addition to quotations and CAD data, design program 125 can output a BOM for a panel design. This can be similar to the parts list generated with a quote. The information in the BOM can be put a format usable by integrated inventory programs or other inventory systems.

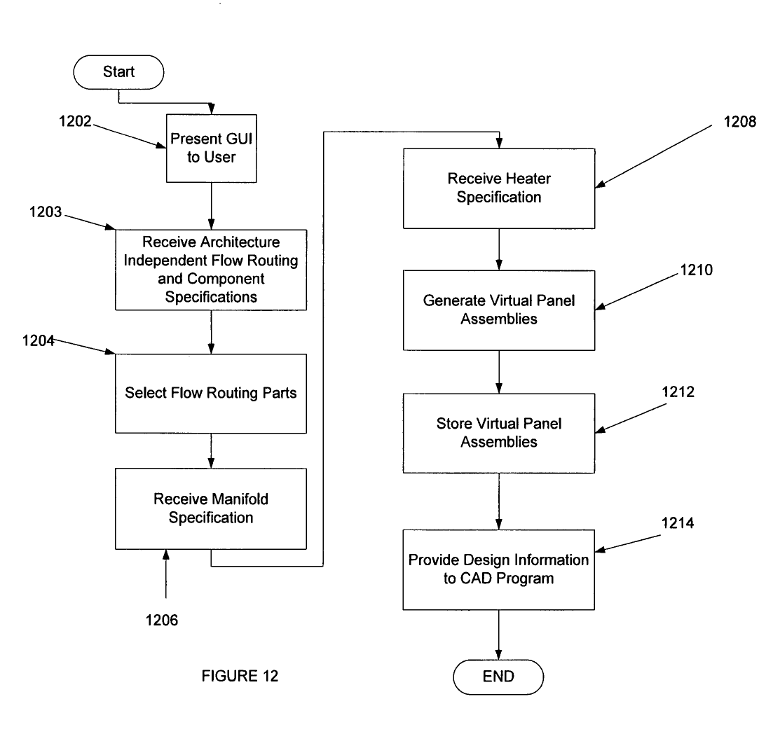

FIG. 12 provides one embodiment of a method for designing a fluid delivery system. The method of claim 12 can be implemented as a set of computer instructions (e.g., design program 125) stored on a computer readable medium, executable by a processor to carry out various steps. At step 1202, a user is presented with a GUI that allows the user to define flow functionalities and component types for locations in a schematic. At step 1203, the inputs provided by the user can be received. It should be noted that the GUI may include multiple screens or a single screen. Based on the input flow functionalities and component types, the corresponding schematic can be presented to the user.

At step 1204 the flow routing parts for one or more architectures can be optionally determined. For each architecture, the flow routing part or parts for a particular location in the schematic can be determined by accessing an n-dimensional array that represents the various criteria for selecting a flow routing part for that architecture. The selection of a flow routing part for a particular location in the schematic can be based on the flow functionality defined for that schematic location, the flow functionalities defined for other schematic locations, the component type orientation required for that schematic location or other criteria.

At step 1206, the GUI can allow a user to provide one or more manifold specifications. At step 1208, the GUI can allow the user to provide one or more heater specifications.

Design program 125, at step 1210, create various virtual panel assemblies by selecting parts for the panel assembly (in this example the flow routing parts have already been selected). If multiple substrate blocks or components are appropriate for an architecture, this can lead to multiple panel assemblies for the same architecture. In creating the virtual panel assemblies, design program 125 can apply selection logic (e.g., based on price or other criteria) to limit the virtual panel assemblies created.

At step 1212, design program 125 can store the virtual panel assemblies (or selected assemblies). If the user selects to output a particular panel assembly to CAD, design program 125, at step 1214, can create transformation matrixes for the each part in the selected assembly, and provide a list of parts and corresponding transformation matrixes to the CAD program (or otherwise provide the information to the CAD program). Additionally, design program 125 can provide information to the CAD program to allow the CAD program to create manifold assemblies and resize heaters. The CAD program can then model the entire assembly in CAD and create various drawings of the panel assembly. It should be noted that other outputs are also possible, such as quotes, BOMS or other outputs. The steps of FIG. 12 can be performed in different orders and can be repeated as needed or desired.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed in the following claims.

What is claimed is:

1. A system for designing a fluid flow panel comprising a set of computer instructions stored on a computer readable medium, the set of computer instructions comprising instructions executable to:
provide a graphical user interface that allows a user to:
specify architecture independent flow functionalities for locations in a schematic of a fluid delivery system;
for at least a first location for which the user specifies a flow functionality, allow the user to specify an architecture independent component type corresponding to the flow functionality for that location; and
determine architecture dependent flow routing parts for the schematic locations for which the user specified flow functionalities for one or more architectures.

2. The system of claim 1, wherein the instructions executable to determine architecture dependent flow routing parts further comprise instructions executable to select substrate blocks for at least one architecture.

3. The system of claim 1, wherein the instructions executable to determine architecture dependent flow routing parts further comprise instructions executable to select substrates blocks for a particular architecture by accessing an n-dimensional array, wherein the n-dimensional array represents criteria for selecting a substrate block.

4. The system of claim 1, wherein the instructions executable to determine architecture dependent flow routing parts further comprise instructions executable to determine the architecture dependent flow routing part for the first location based on the flow functionality specified for the first location.

5. The system of claim 1, wherein the -instructions executable to determine architecture dependent flow routing parts further comprise instructions executable to determine the architecture dependent flow routing part for the first location based on the flow functionality specified for the first location and flow functionalities specified for at least one additional location.

6. The system of claim 1, wherein the instructions executable to determine architecture dependent flow routing parts further comprise instructions executable to determine the architecture dependent flow routing part for the first location based on a required orientation for the component type specified for the first location.

7. The system of claim 1, wherein the GUI further allows the user to specify a component type for a sandwich component.

8. The system of claim 1, wherein the GUI further allows the user specify an architecture dependent component for the first location corresponding to the component type.

9. The system of claim 1, wherein said computer instructions further comprise instructions executable to select an architecture dependent component based on the component type.

10. The system of claim 1, wherein the graphical user interface further allows a user to provide a manifold specification for a manifold between two gas sticks represented in the schematic.

11. The system of claim 1, wherein the graphical user interface further allows a user to provide a heater specification.

12. The system of claim 1, wherein the set of computer instructions further comprise instructions executable to determine a set of parts for a gas panel design according to a particular architecture based on architecture independent inputs provided by the user.

13. The system of claim 12, wherein the set of parts include the architecture dependent flow routing parts and architecture dependent components.

14. The system of claim 13, wherein the set of computer instructions further comprise instructions executable to generate a set of design information for a CAD program that includes a reference to each part in the set of the parts and transform information for each part.

15. The system of claim 13, wherein the set of computer instructions further comprise instructions executable to cause the CAD program to provide a drawing of the gas panel design.

16. A method for designing a fluid flow panel comprising:
receiving architecture independent flow functionalities for locations in a schematic of a fluid delivery system;
for at least a first location for which the user specifies a flow functionality, receiving an architecture independent component type corresponding to the flow functionality for that location; and
determining architecture dependent flow routing parts of the schematic locations for which the user specified flow functionalities for one or more architectures.

17. The method of claim 16, further comprising selecting substrate blocks for at least one architecture.

18. The method of claim 16, wherein determining architecture dependent flow routing parts further comprises selecting substrates blocks for a particular architecture by accessing an n-dimensional array that represents criteria for selecting a substrate block.

19. The method of claim 16, wherein determining architecture dependent flow routing parts further comprises determining the architecture dependent flow routing part for the first location based on the flow functionality specified for the first location.

20. The method of claim 16, wherein determining the architecture dependent flow routing parts further comprises determining the architecture dependent flow routing part for the first location based on the flow functionality specified for the first location and flow functionalities specified for at least one additional location.

21. The method of claim 16, wherein determining the architecture dependent flow routing parts further comprises determining the architecture dependent flow routing part for the first location based on a required orientation for the component type specified for the first location.

22. The method of claim 16, further comprising receiving an architecture dependent component for the first location corresponding to the component type.

23. The method of claim 16, further comprising limiting the choice of architecture dependent flow routing parts to a particular architecture based on the architecture dependent component specified.

24. The method of claim 16, further comprising receiving an architecture independent manifold specification.

25. The method of claim 16, further comprising receiving an architecture independent heater specification.

26. The method of claim 16, further comprising determining a set of parts for a gas panel design according to a particular architecture based on architecture independent inputs provided by the user.

27. The method of claim 16, wherein the set of parts include the architecture dependent flow routing parts and architecture dependent components.

28. The method of claim 27, further comprising generating a set of design information for a CAD program that includes a reference to each part in the set of the parts and transform information for each part.

29. The method of claim 28, further comprising providing the set of design information to the CAD program.

30. The method of claim 28, comprising providing a drawing of the gas panel design.

31. A system for designing a fluid flow panel comprising a set of computer instructions stored on a computer readable medium, the set of computer instructions comprising instructions executable to:
provide a graphical user interface to a user that allows the user to specify architecture impendent specifications for a flow routing layer and component layer for various locations in a schematic of a fluid delivery system; and
determine at least one architecture dependent set of parts for a gas panel based on the architecture independent specifications for the flow routing layer and component layer, wherein the set of parts includes a set of flow routing parts and a set of components.

32. The system of claim 31, wherein the set of computer instructions are further executable to receive a manifold specification for a manifold between two gas sticks represented in the schematic.

33. The system of claim 31, wherein the graphical user interface further allows a user to provide a heater specification.

34. The system of claim 31, wherein the set of computer instructions further comprise instructions executable to generate a set of design information for a CAD program that includes a reference to each part in the set of the parts and transform information for each part.

35. A system for designing a fluid flow panel comprising a set of computer instructions stored on a computer readable medium, the set of computer instructions comprising instructions executable to:
for each of a plurality of architectures, maintain an n-dimensional array representing criteria for selecting substrate blocks for that architecture,
provide a graphical user interface to a user that comprises a schematic grid;
for locations in the schematic grid, allow a user to specify architecture independent flow functionalities;
for at least one location in the schematic grid, allow the user to specify a component type corresponding to the flow functionality specified for that location;
populate the schematic grid with schematic symbols corresponding to the flow functionalities and component types specified for the locations in the schematic grid; and
for each of the plurality of architectures, determine a set of substrate blocks for that architecture using the n-dimensional array for that architecture and the specified architecture independent flow functionalities;
for each of the plurality of architectures, determine a set of architecture dependent components;
generate a virtual gas panel design for at least one architecture based on the determined substrate blocks for that architecture and architecture dependent components for that architecture.

36. The system of claim 35, wherein the set of computer instructions further comprise instructions executable to output a bill of materials, a quote and one or more CAD drawings for the virtual gas panel design.
